(19) United States
(12) Patent Application Publication
(10) Pub. No.: US 2024/0102451 A1
(43) Pub. Date: Mar. 28, 2024

(54) WIND APPARATUS TO MAXIMIZE THE AMOUNT OF KINETIC ENERGY ASSOCIATED WITH AN AIR FLOW CAPTURED OVER TIME BY SAID WIND APPARATUS

(71) Applicant: Consiglio Nazionale Delle Ricerche, Roma (IT)

(72) Inventors: Carmelo LODATO, Roma (IT); Giuseppe MARSALA, Roma (IT)

(21) Appl. No.: 18/473,144

(22) Filed: Sep. 22, 2023

(30) Foreign Application Priority Data
Sep. 23, 2022 (IT) 102022000019611

(51) Int. Cl. F03D 15/00; F03D 9/25; H02K 7/18

(52) U.S. Cl. CPC F03D 15/00; F03D 9/25; H02K 7/183; F05B 2260/40

(57) ABSTRACT

The present invention relates to a wind apparatus to maximize the amount of kinetic energy associated with an air flow captured over time by said wind apparatus.

In particular, said wind apparatus comprises at least one wind system, wherein said wind system comprises at least one a bladed device provided with one or more blades and configured to be electronically controlled so that its aerodynamic behaviour changes over time based on the action exerted by said air flow on said one or more blades of said bladed device.

The present invention relates to a wind apparatus to maximize the amount of kinetic energy associated with an air flow captured over time by said wind apparatus.

In particular, the invention relates to a structure of a wind apparatus comprising at least one bladed device provided with at least one blade, wherein said bladed device is controlled to change its aerodynamic behaviour over time based on the action exerted by said air flow over time on said one or more blades of said bladed device.

An air flow is due to a pressure difference (i.e. air moves from a high pressure zone to a low pressure zone).

The air flow can be an air flow generated by a natural cause, such as a change in pressure from meteorological origin, or an air flow generated by a moving object, such as a moving elevator or a moving vehicle, such as a vehicle moving through a gallery or tunnel.

The vehicle can be a train or a subway or a truck or a car.

### PRIOR ART

Currently, several wind apparatus are known to capture the kinetic energy contained in an air flow.

This kinetic energy is transformed into mechanical energy and this mechanical energy is transformed into electrical energy through a wind-powered generator.

A first example of a known type of wind apparatus for generating electric energy consists of a wind turbine generator.

In general, there are two categories of wind generator: a horizontal axis wind generator and a vertical axis wind generator.

A horizontal axis wind generator is mainly used in an environment where the wind direction does not vary significantly.

A vertical axis generator is mainly used in an environment where the wind direction can vary significantly.

However, regardless of the type of wind generator, said horizontal axis wind generator and said vertical axis wind generator have some common disadvantages.

A first disadvantage is given by the fact that said wind generators supply a maximum power in a predetermined range of wind speed values.

Furthermore, the efficiency of said wind generators decreases when the intensity and/or direction of the wind changes/change rapidly over time.

Therefore, each type of wind generator is chosen and sized according to the characteristics of the air flow present in the site where said wind generator is to be positioned.

A second disadvantage is given by the cost due to the need to design and build a wind generator with technical characteristics (referring, for example, to the materials used for the components) which take into account the characteristics of the environment (referring to the presence of harmful elements for the components of the wind generator) in which said wind generator is positioned to prevent said wind generator from being damaged.

For example, in sites where debris and/or dust are present and/or can be carried by the air, these wind generators can be easily damaged, so that repair interventions are necessary with the consequent costs.

### AIM OF THE INVENTION

The aim of the present invention is to overcome said disadvantages, providing a wind apparatus for maximizing the amount of kinetic energy associated with an air flow captured over time by said wind apparatus, wherein said wind apparatus has a simple mechanical structure and a low manufacturing cost, and comprises at least one bladed device provided with one or more blades, wherein said bladed device is controlled to change its aerodynamic behaviour over time based on the action exerted by said air flow on said one or more blades.

Consequently, said wind apparatus is designed to capture an amount of kinetic energy even when the intensity and/or direction of an air flow changes/change rapidly over time.

In particular, said at least one bladed device can be shaped and sized to be positioned in any site and said wind apparatus is provided with a logic control unit to change the aerodynamic behaviour of said bladed device over time based on the action exerted by said airflow on said one or more blades of said bladed device.

### OBJECT OF THE INVENTION

The object of the invention is a wind apparatus according to claim 1.

Further preferred embodiments of said wind apparatus are described in the dependent claims.

### ATTACHED FIGURE LIST

The present invention will be now described, for illustrative, but not limitative purposes, according to its embodiments, making particular reference to the enclosed figures, wherein:

FIG. 1 shows a first embodiment of the wind apparatus comprising a first wind system, wherein said first wind system comprises a first bladed device;

FIG. 2 shows the wind apparatus of FIG. 1 in which a part of the frame has been removed to show the first bladed device of the first wind system;

FIG. 3 shows the first bladed device of the first wind system of the wind apparatus of FIG. 1;

FIG. 4 shows a first alternative referring to the connection means for connecting a first rotating element of the first bladed device to a first shaft;

FIGS. 5A and 5B show a second alternative referring to the connection means for connecting a first rotating element of the first bladed device to a first shaft, when a slider of the first bladed device moves respectively in a first direction and in a second direction, opposite to said first direction;

FIG. 6 is a first view showing the first bladed device of the first wind system connected to a plurality of electric energy generators;

FIG. 7 is a second view showing the first bladed device of the first wind system connected to a plurality of electric energy generators;

FIG. 8 shows a second embodiment of the first wind system comprising a further first bladed device;

FIG. 9A shows a detail referring to the connecting means for connecting said further first bladed device to the first bladed device;

FIG. 9B shows a detail referring to a further rotating element of said connecting means for connecting said further first bladed device to the first bladed device;

FIG. 10 shows a third embodiment of the wind apparatus comprising a second wind system comprising a second bladed device;

FIG. 11 shows the wind apparatus of FIG. 10 from which the frame has been removed to show in detail the second wind system comprising the second bladed device, as well as the first wind system comprising a first bladed device and a further first bladed device;

FIGS. 12A and 12B show the connecting means for connecting a second rotating element of the second bladed device to a second shaft, when a slider of the second bladed device moves respectively in a first direction and in a second direction, opposite to said first direction;

FIG. 13 is a first view showing the second bladed device of the second wind system connected to the same plurality of electric power generators to which the first bladed device and the further first bladed device of the first wind system are connected;

FIG. 14 is a second view showing the second bladed device of the second wind system connected to the same plurality of electric power generators to which the first bladed device and the further first bladed device of the first wind system are connected;

FIG. 15 is a third view showing a first shaft of the first wind system and a second shaft of the second wind system connected to a gearbox by which the first bladed device and the further first bladed device of the first wind system and the second bladed device of the second wind system are connected to said plurality of electric energy generators;

FIG. 16 shows a fourth embodiment in which said wind apparatus comprises a third wind system comprising a third bladed device;

FIG. 17 shows a detail of the third wind system of FIG. 16 relating to a blade constrained to a slider sliding in a guide element;

FIG. 18 is a view of a further detail of the third wind system of FIG. 16 relative to motion transmission means for transmitting the motion from a third rotating element to a third shaft of said third wind system;

FIG. 19 is a view of the further detail shown in FIG. 18, in which the third shaft of the third bladed device of the third wind system is connected to a plurality of electric energy generators.

### DETAILED DESCRIPTION OF THE INVENTION

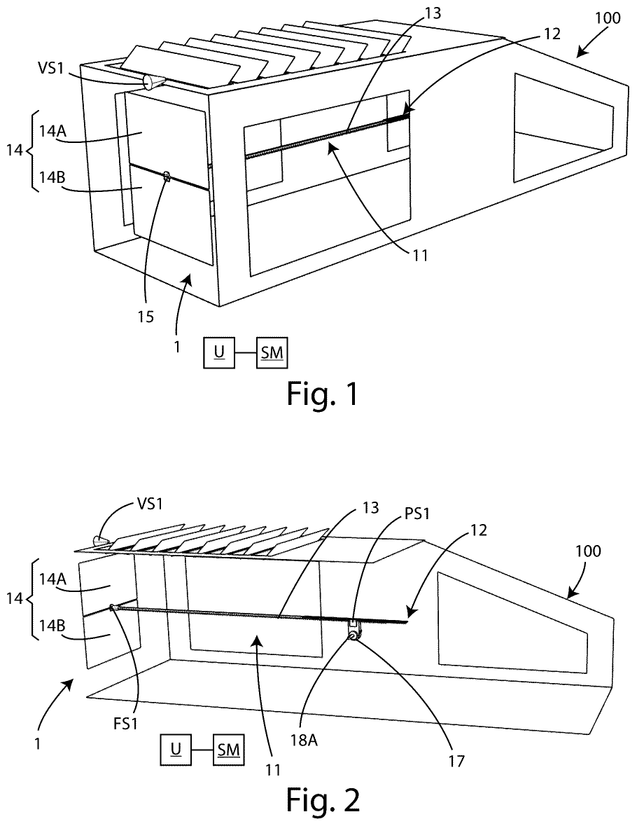

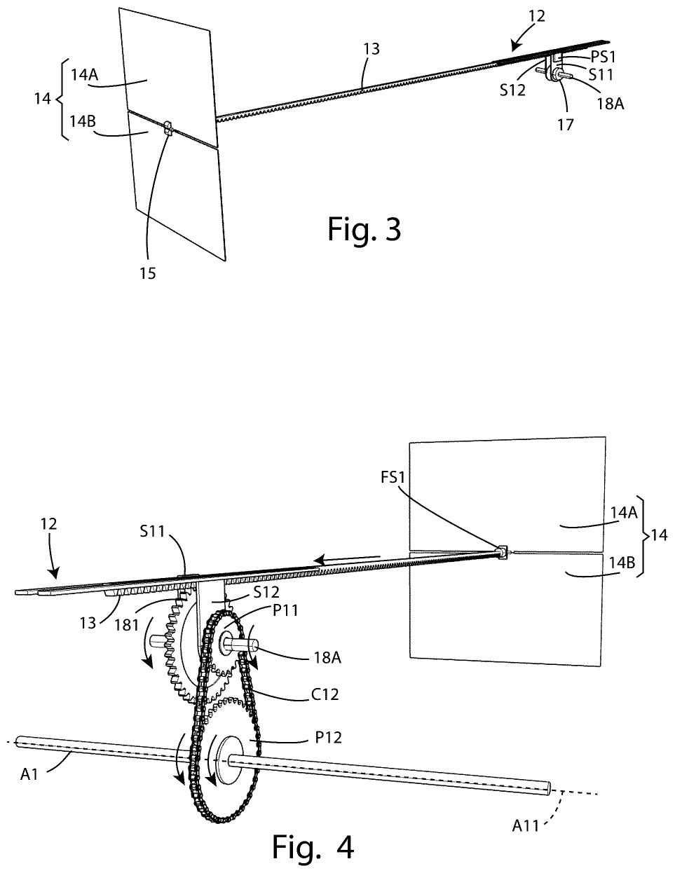

With particular reference to FIG. 1, a first embodiment of a wind apparatus is described for maximizing the amount of kinetic energy associated with an air flow captured over time by said wind apparatus.

The figures show different wind systems that can be part of the wind system, individually or in combination with each other.

Furthermore, the airflow is not shown in the figures.

For simplicity, the direction of said air flow can be considered horizontal, for example from left to right.

However, the direction of the air flow can be any direction, without departing from the scope of the invention.

Said first wind system 1 comprises at least one first bladed device 11 comprising:
a first guide element 12 defining a first trajectory comprising one or more segments, each of which is delimited by a first end point and a second end point,
a first slider 13 sliding on said first guide element 12 in a first direction and in a second direction, opposite to said first direction,
at least one first blade 14 orientable in space with respect to a direction of an air flow and constrained to said first slider 13 in such a way that, when said airflow incides on said first blade 14, said airflow moves said first blade 14 and the movement of said first blade 14 causes the movement of said first slider 13 along said first guide element 12 in said first direction or in said second direction,
first blade rotation means 15 for rotating said first blade 14 in space with respect to said first slider 13, so as to change an angle between said first blade 14 and the direction of said air flow.

As shown in FIG. 1, the wind apparatus comprises a frame 100 and said first bladed device 11 is arranged inside said frame 100.

The frame 100 is sized and shaped to receive the first wind system and ensure the correct positioning of each element of said at least one first bladed device 11.

In the embodiment being described, said frame 100 is schematically represented by a box-like body.

However, the frame 100 can have any shape and size, without departing from the scope of the invention.

With reference to said first guide element 12, in the example being described, said first guide element 12 has a rectilinear shape, so that each segment of said first trajectory is a rectilinear segment.

However, said first guide element 12 can have a shape other than rectilinear, without departing from the scope of the invention.

With reference to said first slider 13, in the embodiment being described, said first slider 13 is a first rack.

With reference to said first blade 14, said first blade 14 can comprise at least a first part 14A and a second part 14B connected to each other.
Said first blade rotating means 15 are configured to rotate said first part 14A and said second part 14B independently of each other, so that an aerodynamic force acting on said first blade 14 is maximized along the same direction in which the first slider 13 moves along said first guide element 12 and the aerodynamic behaviour of said first bladed device 11 changes over time to maximize the amount of kinetic energy of said air flow captured by said first blade 14.
   In particular, said first part 14A and said second part 14B of said first blade 14 are movable between:
a first position, wherein said first part 14A and said second part 14B of said first blade 14 lie on a first plane, perpendicular to the direction of said air flow, so that said first blade 14 offers the maximum aerodynamic resistance to the air flow that incides on said first blade 14 and that said air flow moves said first blade 14 in said first direction along said segment of said first trajectory, and
a second position, wherein said first part 14A and said second part 14B of said first blade 14 are overlapped and lie on a second plane, perpendicular to said first plane and parallel to the direction of said air flow, so that said first blade 14 offers the minimum aerodynamic resistance to the air flow that incides on said first blade 14, when said first blade 14 moves in said second direction along said segment of said first trajectory.

With reference to said first blade rotation means 15, said first blade rotation means 15 can comprise a first electro-mechanical actuator configured to receive a signal from the control logic unit (mentioned below) and to rotate said first blade 14.

In the embodiment being described, said first blade rotating means 15 comprise a first hinge connected to the first part 14A and to the second part 14B of the first blade 14 to rotate said first part 14A and said second part 14B, wherein said first hinge is an electric hinge configured to be controlled by said control logic unit U. Consequently said first hinge is provided with a control module for receiving a signal sent by control logic unit U and for rotating said first blade 14.

Said first wind system 1 comprises at least one first position sensor PS1 for detecting the position of said first blade 14.

The expression “position of the first blade” means the position of the point where said first blade 14 is constrained to said first slider 13.

The position of the first blade 14 can coincide with the position of the first slider 13 with respect to a reference on the first bladed device 11.

In the example being described, said first position sensor PS1 is preferably included in said first bladed device 11.

With reference to said first position sensor PS1, said first position sensor PS1 is positioned on first supporting means for supporting first guide rotation means 17 (mentioned later), wherein said first supporting means are connected to the first support element guide 12.

In particular, said first supporting means comprise a first bracket S11 and a second bracket S12, facing the first bracket S11, and said first position sensor PS1 is arranged on an end portion of said first bracket S11.

Said first supporting means comprise a shaft 18A which passes through a respective hole of each bracket S11, S12.

Said wind apparatus comprises storage means SM and a logic control unit U connected to said storage means SM, as well as to said first position sensor PS1 and to said first blade rotating means 15.

With reference to said storage means SM, at least the following data are stored in said storage means SM:
the position of each end point of each segment of said first trajectory (i.e. the position of the first end point and the position of the second end point of each segment of said first trajectory),
for each end point of each segment of said first trajectory a plurality of predetermined distances between said first slider 13 and said end point, wherein each predetermined distance of said plurality of predetermined distances is associated with a respective predetermined velocity of said first blade 14, with a respective predetermined orientation of said first blade 14 and with a respective predetermined orientation of a segment of said first trajectory.

Said segment can be the segment on which said first blade 14 moves to reach an end point (which may be said first end point or said second end point) or the segment towards which said first blade moves, i.e. the segment arranged in succession to the segment on which said first blade moves.

In the first embodiment being described, said storage means SM comprise a memory and are external to the control logic unit U.

However, said storage means SM can be included in said control logic unit U, without departing from the scope of the invention.

Before going into the details of the tasks performed by the control logic unit U, it should be noted that, when reference is made to the velocity of a blade, said velocity is a vector quantity.

As known, a vector quantity is defined by at least three parameters: the module also called intensity, the direction and orientation.

Therefore, in description, the terms “module” and “intensity” have the same meaning.

In the next sentence reference will be made to the velocity of the first blade 14, however, the concept that the velocity of a blade is a vector quantity is to be applied also to the velocity of a further first blade 14′, to the velocity of a second blade 24 and to the velocity of a third blade 34, mentioned later in this description.

With reference to the logic control unit U, said logic control unit U is configured to:
acquire overtime a plurality of positions of said first slider 13, through said first position sensor PS1,
calculate:
a first position difference between a position of said first slider 13 acquired in a time instant tⱼ, with j=1, 2 . . . N, wherein N is a positive integer, and a position acquired in a previous time instant tⱼ₋₁, a time difference between said time instant tⱼ and said previous time instant tⱼ₋₁,
a second position difference between the position of an end point of a segment of said first trajectory towards which said first blade 14 moves, wherein said position is stored in said storage means SM, and the position of said first slider 13 (acquired through said first position sensor PS1),
the velocity of said first blade 14 with an intensity or module equal to the ratio between said first position difference and said time difference, and
the distance of said first blade 14 with respect to said end point of said segment of said first trajectory equal to the result of said second position difference,
when said distance (i.e. the distance of said first blade 14 with respect to said end point of said segment of said first trajectory) is equal to a predetermined distance of said plurality of predetermined distances, send a signal to said first blade rotation means 15 for rotating said first blade 14 in such a way that said first blade 14 has an orientation equal to a stored predetermined orientation which is selected on the basis of the correspondence between the distance of said first slider 13 from an end point of said segment of said first trajectory and a predetermined distance stored and the correspondence between the calculated velocity of said first blade and a stored predetermined velocity of said first blade, so that the aerodynamic behaviour of said first bladed device 11 changes over time to maximize the amount of kinetic energy of said air flow captured by said first blade 14.

It is preferable that said first bladed device 11 comprises first guide rotation means 17 for rotating said first guide element 12 in the space.

With reference to said first guide rotation means 17, said first guide rotation means 17 can comprise a further electro-mechanical actuator for receiving a signal sent by the logic control unit U and for rotating said first guide element 12 around said shaft 18A (i.e. the shaft passing through the holes of the two brackets S11, S12 mentioned above).

For example said electro-mechanical actuator can be a stepping motor.

Furthermore, in the example being described, said first guide rotation means 17 are arranged around said shaft 18A and positioned on a further end portion of said first bracket S11 of said first support means. Although not shown in the figure, said first guide rotation means 17 are connected or fixed to a first portion of the frame 100 of the wind apparatus, for example by means of a first bar.

Said logic control unit U can be configured to send a signal to said first rotation means 17 for rotating said first guide element 12 in such a way that said first guide element 12 has an orientation equal to a stored predetermined orientation which is selected on the basis of the correspondence between the distance of said first slider 13 from an end point of said segment of said first trajectory and a stored predetermined distance and the correspondence between the calculated velocity of said first blade and a stored predetermined velocity of said first blade, so that the aerodynamic behaviour of said first bladed device 11 changes over time to further maximize the amount of kinetic energy of said air flow captured by said first blade 14.

Furthermore, said first wind system 1 can comprise:
at least one first velocity sensor VS1 for detecting the velocity of the air flow incident on said first blade 14, and
at least one first force sensor FS1 for detecting a force acting on said first blade 14.
   The following data can be further stored in said storage means SM:
a plurality of predetermined air flow velocities, and
a plurality of predetermined forces, wherein each predetermined force of said plurality of predetermined forces is associated with a respective predetermined air flow velocity of said plurality of predetermined air flow velocities, a respective predetermined velocity of said first slider 13, a respective predetermined orientation of said first blade 14 and a respective predetermined orientation of said segment of said first trajectory on which said first blade 14 moves to reach an end point.
   Said logic control unit U can be configured to:
acquire a plurality of velocities of the air flow over time, through said first velocity sensor VS1,
acquire a plurality of forces acting on said first blade 14 over time, through said first force sensor FS1,
compare
the velocity of the air flow detected through said first velocity sensor VS1 with each predetermined air flow velocity stored in said storage means SM, and
the velocity of said first blade 14 with each predetermined velocity of said first blade stored in said storage means SM,
to obtain a predetermined force selected on the basis of the correspondence between the acquired air flow velocity and a stored predetermined air flow velocity and of the correspondence between the calculated velocity of said first blade and a stored predetermined velocity of said first blade,
compare each acquired force with said predetermined force,
if an acquired force is less than said predetermined force, send a signal to said first blade rotation means 15 to rotate said first blade 14 in such a way that said first blade 14 has an orientation equal to a stored predetermined orientation which is selected on the basis of said predetermined force.

Said logic control unit U can be configured to send a signal to said first guide rotation means 17 to rotate said first guide element 12 so that said first guide element 12 has an orientation equal to a stored predetermined orientation which is selected on the basis of the correspondence between the acquired air flow velocity and a stored predetermined air flow velocity and the correspondence between the calculated velocity of said first blade and a stored predetermined velocity of said first blade.

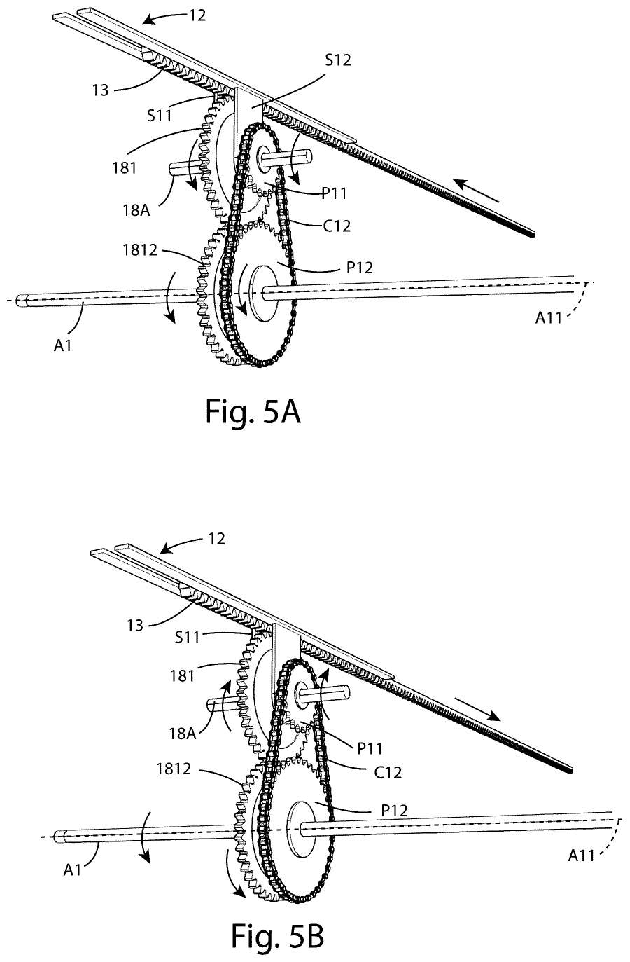

Said first wind system 1 can comprise (FIGS. 4 and 5):
a first motion transmission mechanism comprising:
   at least one first rotating element 181 connected to said first slider 13 in such a way that the movement of said first slider 13, due to the movement of said first blade 14 in said first direction or in said second direction, causes respectively the rotation of said first rotating element 181 in a first direction or in a second direction,
   a first shaft A1 having a rotation axis A11 and configured to rotate around said rotation axis A11 in a predetermined direction,
   first connecting means for connecting said first rotating element 181 to said first shaft A1, in such a way that the rotation of said first rotating element 181 in said first direction causes the rotation of said first shaft A1 in said predetermined direction or that the rotation of said first rotating element 181 in said first direction and in said second direction causes the rotation of said first shaft A1 in said predetermined direction.

Said first wind system 1 is configured to transfer said amount of kinetic energy to said first shaft A1, so that the kinetic energy of the air flow is transformed in rotation mechanical energy of said first shaft A1.

Regardless of whether the first rotating element 181 rotates in a first direction or in a second direction, the first shaft A1 (connected to said first rotating element 181) rotates in only one predetermined direction.

In the example being described, with reference to said first motion transmission mechanism, said first rotating element 181 is a first gearwheel which is engaged with said first slider 13 (i.e. said first rack) and rotates with the shaft 18A which passes through each hole of the above mentioned brackets S11, S12.

Said first rotating element 181 is arranged between said first bracket S11 and said second bracket S12.

With reference to said first connecting means, in a first alternative (shown in FIG. 4), said first connecting means can comprise a pulley P11 rotating with the same shaft 18A with which said first rotating element 181 rotates.

Said pulley P11 is connected to a further pulley P12 by means of a belt C12, wherein said further pulley P12 is a freewheel pulley and rotates around said first axis A11.

In particular, when said further pulley P12 rotates around said first axis A11 in said first direction it causes rotation of said first shaft A1 in said first direction (in the example being described the first direction of the first shaft A1 coincides with the predetermined direction).

When said further pulley P12 rotates about said first axis A11 in said second direction, said further pulley P12 rotates idle with respect to said first shaft A1 and therefore does not exert any action on said first shaft A1.

In particular, when said first slider 13 (i.e. said first rack) moves in a first direction, said first rotating element 181 causes rotation of said shaft 18A in a first direction.

The rotation of said shaft 18A causes the rotation of said pulley P11 in a first direction and, through said belt C12, the motion of pulley P11 is transmitted to the further pulley P12, so that said further pulley P12 rotates around said first axis A11 in a first direction causing rotation of said first shaft A1 in its predetermined direction.

When said first slider 13 (i.e. said first rack) moves in a second direction, opposite to said first direction, said first rotating element 181 causes rotation of said shaft 18A in a second direction.

The rotation of said shaft 18A causes the rotation of said pulley P11 in a second direction and, through said belt C12, the motion of pulley P11 is transmitted to the further pulley P12, so that said further pulley P12 rotates around said first axis A11 in a second direction.

However, as mentioned above, in this case, said further pulley P12 rotates idle with respect to said first shaft A1 and therefore does not affect the rotation of said first shaft A1.

In other words, in said first alternative, said first shaft A1 rotates in its predetermined direction only when said first slider 13 moves in said first direction.

In a second alternative (shown in FIGS. 5A and 5B), differently from the first alternative, said first connecting means can comprise a further gear wheel 1812 engaged with said first rotating element 181 (i.e. said first gear wheel) and rotating around said first axis A11.

Said further gear wheel 1812 is a freewheel gear wheel.

In particular, when said further gear wheel 1812 rotates around said first axis A11 in said first direction it causes rotation of said first shaft A1 in said first direction (in the example being described the first direction of the first shaft coincides with the predetermined direction).

When said further gear wheel 1812 rotates about said first axis A11 in said second direction, said further gearwheel 1812 rotates idle with respect to said first shaft A1 and therefore does not exert any action on said first shaft A1.

In said second alternative, when the further pulley P12 rotates in a first direction, the further gear wheel 1812 rotates idle around the first shaft A1 in a second direction.

The rotation of said further pulley P12 causes the rotation of said first shaft A1 in its predetermined direction.

When the further gearwheel 1812 rotates about said first axis A11 in said first direction, the further pulley P12 rotates idle about said first shaft A1 in said second direction.

The rotation of said further gearwheel 1812 in said first direction causes rotation of said first shaft A1 in said first direction (which, as already mentioned, coincides with the predetermined direction).

In other words, in said second alternative, said first shaft A1 rotates in its predetermined direction both when said first slider 13 moves in said first direction and when it moves in said second direction.

Advantageously, by means of this latter alternative, said first blade 14 can capture kinetic energy even when the direction of the air flow changes rapidly overtime from a first direction to a second direction and vice versa.

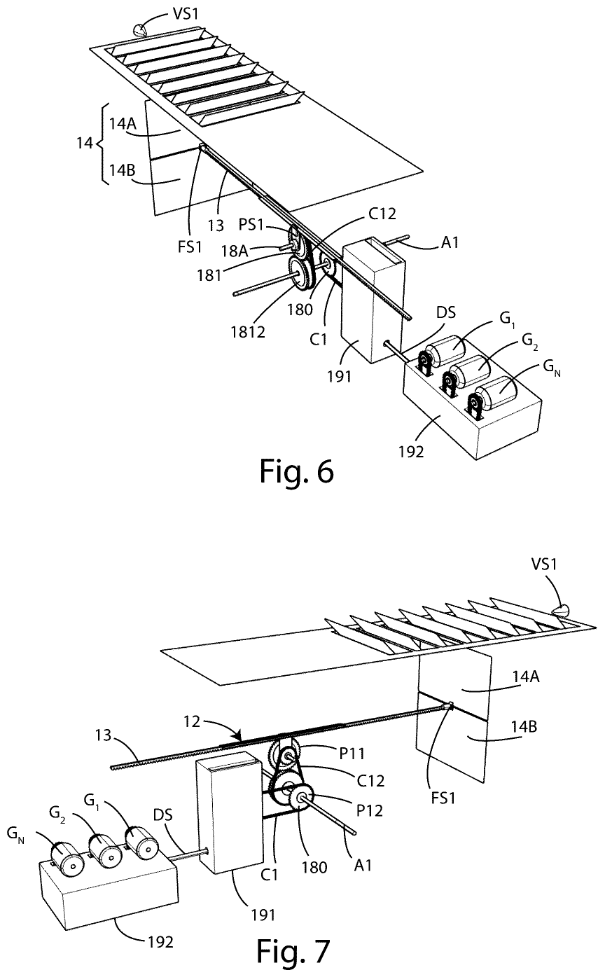

As shown in FIG. 6, said wind apparatus can comprise:
a drive shaft DS,
a motion transmission mechanism for transmitting the motion to said drive shaft DS comprising:
   connecting means for connecting said first shaft A1 to said drive shaft DS, so that the rotation of said first shaft A1 causes the rotation of said drive shaft DS.

With reference to said connecting means for connecting said first shaft A1 to said drive shaft DS, said connecting means for connecting said first shaft A1 to said drive shaft DS comprise:
a first input shaft (not shown),
a gearwheel (not shown) rotating with said first input shaft,
a first output shaft (not shown) connected to said drive shaft DS, and
a gear wheel 180 rotating with said first shaft A1 and connected, by means of a belt C1, to said gear wheel rotating with said first input shaft.

In particular, the first input shaft, the rotating gear wheel with said first input shaft and the first output shaft are arranged inside a gearbox 191, while the gear wheel 180 rotating with said first shaft A1 is external to said 191 gearbox.

The first output shaft is connected to the drive shaft DS via a first mechanical element (not shown) which is arranged inside the gearbox 191.

Said first mechanical element can be a first friction element, for example a first friction gear wheel.

The gearbox 191 further comprises a first plurality of mechanisms for connecting said first input shaft to said first output shaft so as to vary the transmission ratio between said first input shaft and said first output shaft.

At least one mechanism of said first plurality of mechanisms can be an electromechanical device configured to receive a signal from the logic control unit U to vary said transmission ratio.

Accordingly, the control logic unit U can be configured to send a signal to said at least one mechanism of said first plurality of mechanisms to vary said transmission ratio.

In other words, the motion of the first shaft A1 is transmitted via the belt C1 to the first input shaft inside the gearbox 191, and via said first plurality of mechanisms from the first input shaft to the first output shaft and finally via the first mechanical element from the first output shaft to the drive shaft DS.

In the example being described, said drive shaft DS is partially arranged inside said gearbox 191.

In the first embodiment being disclosed, said wind apparatus comprises a plurality of electric energy generators G₁, G₂ . . . G_{N} to generate electric energy.

Each electric energy generator G₁, G₂ . . . G_{N} of said plurality of electric energy G₁, G₂ . . . G_{N} comprises a respective shaft and one or more shafts of respective electric energy generators G₁, G₂ . . . G_{N} of said plurality of electric energy generators G₁, G₂ . . . G_{N} are connected to said drive shaft DS.

Consequently, the number of electric energy generators connected to said drive shaft DS can be equal to one or greater than one.

Said motion transmission mechanism for transmitting motion from said drive shaft DS to at least one shaft of a respective electric energy generator G₁, G₂ . . . G_{N}, comprises connecting means for connecting/disconnecting said drive shaft DS to/from one or more respective shafts of electric energy generators G₁, G₂ . . . G_{N} of said plurality of electric energy generators G₁, G₂ . . . G_{N}.

With reference to said connecting means for connecting/disconnecting said drive shaft DS to/from one or more respective shafts of electric energy generators G₁, G₂ . . . G_{N}, said connecting means for connecting/disconnecting said drive shaft DS to/from one shaft of an electric energy generators comprise:
a further gearbox 192 comprising a further plurality of mechanisms to vary the transmission ratio between the drive shaft DS and the shaft of each electric energy generators G₁, G₂ . . . G_{N}.

In particular, said further gearbox 192 comprises inside:

A respective mechanism (not shown), such as a bevel gear, for each electric energy generator G₁, G₂ . . . G_{N}, in which each mechanism is connected to said drive shaft DS,
a respective gear wheel (not shown) for each electric energy generator G₁, G₂ . . . G_{N}, wherein each gearwheel is connected to a shaft of a respective electric energy generator G₁, G₂ . . . G_{N}, by means of a respective belt,
a respective electromechanical device (not shown), for example a friction disc, for connecting/disconnecting said mechanism to said gear wheel.

Each electromechanical device is configured to receive a signal by said logic control unit U so as to connect/disconnect the shaft of a respective electric energy generator G₁, G₂ . . . G_{N} to/from the drive shaft DS.

A plurality of predetermined power values and a respective predetermined number of electric energy generators associated with each predetermined power value of said plurality of predetermined power values are stored in said storage means SM.

Said logic control unit U is configured to:
calculate a power value starting from the force acquired through said first force sensor FS1 and from the calculated velocity of said first blade and from the number of said one or more electric energy generators G₁, G₂ . . . G_{N} connected to said drive shaft DS,
compare said power value with each predetermined power value to determine the predetermined number of electric energy generators associated with said predetermined power value,
compare the number of electric energy generators G₁, G₂ . . . G_{N} connected to said drive shaft DS with said predetermined number of electric energy generators,
if the number of electric energy generators G₁, G₂ . . . G_{N} connected to said drive shaft DS is less than said predetermined number of electric energy generators,
calculate a difference between said predetermined number of electric energy generators and said number of electric energy generators and the result of said difference is the number of electric energy generators G₁, G₂ . . . G_{N} to be connected to said drive shaft DS, and
send a control signal to said connecting means containing an information concerning the result of said difference to connect a respective number of electric energy generators to said drive shaft DS,
if the number of electric energy generators G₁, G₂ . . . G_{N} connected to said drive shaft DS is greater than said predetermined number of electric energy generators,
calculate a difference between said number of electric energy generators G₁, G₂ . . . G_{N} and said predetermined number of electric energy generators and the result of said difference is the number of electric energy generators G₁, G₂ . . . G_{N} to be disconnected from said drive shaft DS, and send a control signal to said connecting means containing an information concerning the result of said difference to disconnect a respective number of electric energy generators from said drive shaft DS.

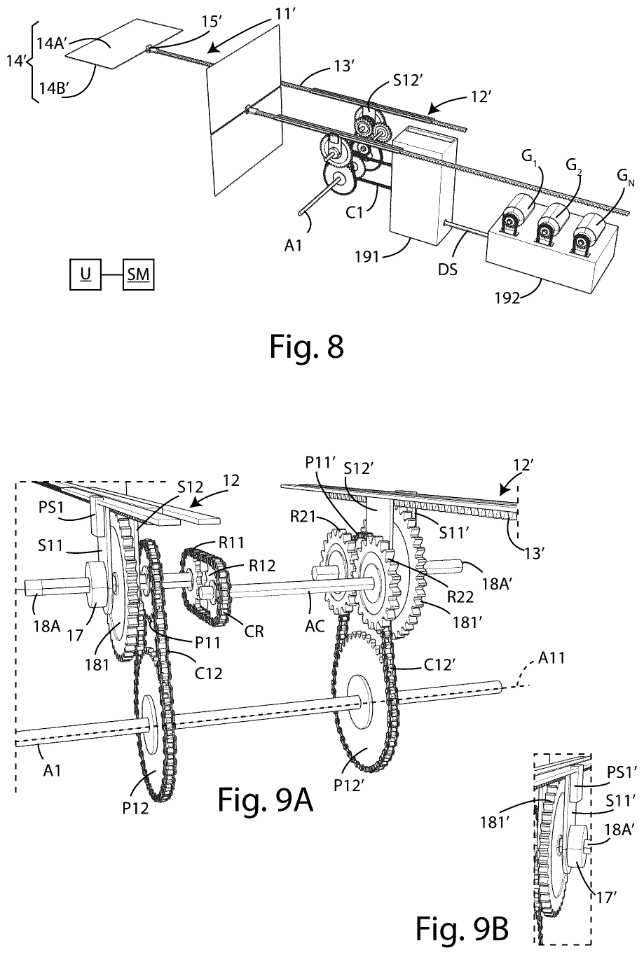

In a second embodiment, shown in FIG. 8, said first wind system 1 comprises a further first bladed device 11′.

Said further first bladed device 11′ comprises:
a further first guide element 12′ defining a further first trajectory comprising one or more segments, each of which is delimited by a first end point and a second end point,
a further first slider 13′ sliding on said further first guide element 12′ in a first direction and in a second direction, opposite to said first direction, at least one a further first blade 14′ orientable in space with respect to a direction of said air flow and constrained to said further first slider 13′ in such a way that, when said air flow incides on said further first blade 14′, the movement of said further first blade 14′ causes the movement of said further first slider 13′ along said further guide element 12′ in said first direction or in said second direction,
further first blade rotation means 15′ for rotating said further first blade 14′ in space with respect to said further first slider 13′.

With reference to said further first guide element 12′, in the example being described, said further first guide element 12′ has a rectilinear shape, so that each segment of said further first trajectory is a rectilinear segment.

However, said further first guide element 12′ can have a shape other than rectilinear, without departing from the scope of the invention.

With reference to said further first slider 13′, in the embodiment being described, said further first slider 13′ is a further first rack.

With reference to said further first blade 14′, said further first blade 14′ can comprise at least a first part 14A′ and a second part 14B′ connected to each other.

Said further first blade rotation means 15′ are configured to rotate said first part 14A′ and said second part 14B′ of said further first blade 14′ independently of each other, so that an aerodynamic force acting on said further first blade 14′ is maximized along the same direction in which said further first slider 13′ moves along said further first guide element 12′ and the aerodynamic behaviour of said further first bladed device 11′ changes over time to maximize the amount of kinetic energy of said air flow captured by said further first bladed device 14′.

In particular, said first part 14A′ and said second part 14B′ of said further first blade 14′ are movable between:
a first position, wherein said first part 14A′ and said second part 14B′ of said further first blade 14′ lie on a first plane, perpendicular to the direction of said air flow, so that said further first blade 14′ offers the maximum aerodynamic resistance to the air flow that incides on said further first blade 14′ and that said air flow moves said further first blade 14′ in said first direction along said segment of said further first trajectory, and
   a second position, wherein said first part 14A′ and said second part 14B′ of said further first blade 14′ are overlapped and lie on a second plane, perpendicular to said first plane and parallel to the direction of said air flow, so that said further first blade 14′ offers the minimum aerodynamic resistance to the air flow that incides on said further first blade 14′ when said further first blade 14′ moves in said second direction along said segment of said further first trajectory.

With reference to said further first blade rotation means 15′, said further first blade rotation means 15′ can comprise a further first electro-mechanical actuator configured to receive a signal from the logic control unit and to rotate the further first blade 14′.

In the embodiment being described, said further blade rotation means 15′ comprise a further first hinge connected to the first part 14A′ and to the second part 14B′ of the further first blade 14′ to rotate said first part 14A′ and said second part 14B′, wherein said further first hinge is a further electric hinge configured to be controlled by said control logic unit U. Accordingly said further first hinge is provided with a control module for receiving a signal sent by the logic control unit U e to rotate said further first blade 14′.

Said first wind system 1 comprises a further first position sensor PS1′ to detect the position of said further first blade 14′.

The expression “position of the further first blade” means the position of the point at which said further first blade 14′ is constrained to said further first slider 13′.

The position of the further first blade 14′ can coincide with the position of the further first slider 13′ with respect to a reference on the further first bladed device 11′.

In the example described, said further first position sensor is preferably included in said further first bladed device 11′.

With reference to said further first position sensor PS1′ (FIG. 9B), said further first position sensor PS1′ is positioned on further first supporting means for supporting further first guide rotation means 17′ (mentioned later), wherein said further first supporting means are connected to the further first guide element 12′.

In particular, said further first supporting means comprise a first bracket S11′ and a second bracket S12′, facing the first bracket S11′, and said further first position sensor PS1′ is arranged on an end portion of said first bracket S11′.

Said further first supporting means comprise a shaft 18A′ (shown in FIGS. 9A and 9B) which passes through a respective hole of each bracket S11′, S12′ of said further first support means.

With reference to the second embodiment of the wind apparatus, the following data are further stored in said storage means SM:
the position of each end point of each segment of said further first trajectory (i.e. the position of the first end point and the position of the second end point of each segment of said further first trajectory),
for each end point of each segment of said further first trajectory a plurality of predetermined distances between said further first slider 13′ and said end point, wherein each predetermined distance of said plurality of predetermined distances is associated with a respective predetermined velocity of said further first blade 14′, with a respective predetermined orientation of said further first blade 14′ and with a respective predetermined orientation of a segment of said further first trajectory.

Said segment can be the segment on which said further first blade 14′ moves to reach an end point (which can be the first end point or the second end point) or the segment towards which said further first blade 14′ moves, i.e. the segment arranged in succession to the segment to which said further first blade moves.

In the second embodiment being described, said logic control unit U can be configured to:
said logic control unit (U) is configured to:
   acquire over time a plurality of positions of said further first slider 13′, through said further first position sensor PS1′,
   calculate:
   a first position difference between a position of said further first slider 13′ acquired in time instant tⱼ, with j=1, 2 . . . N, wherein N is a positive integer, and a position acquired in a previous time instant tⱼ₋₁,
   a time difference between said time instant tⱼ and said previous time instant tⱼ₋₁,
   a second position difference between the position of an end point of a segment towards said further first blade 14′ moves, wherein said position is stored in said storage means SM, and the position of said further first slider 13′,
   the velocity of said further first blade 14′ with an intensity or module equal to the ratio between said first position difference and said time difference, and
   the distance of said further first blade 14′ with respect to said end point of said segment of said further first trajectory equal to the result of said second position difference,
   when said distance is equal to a predetermined distance of said plurality of predetermined distances, send a signal to said further first blade rotation means 15′ for rotating said further first blade 14′ in such a way that said further first blade 14′ has an orientation equal to a stored predetermined orientation which is selected on the basis of the correspondence between the distance of said further first slider 13′ from an end point of said segment of said further first trajectory and a stored predetermined distance and on the correspondence between the calculated velocity of said further first blade and a stored predetermined velocity of said further first blade, so that the aerodynamic behaviour of said further first bladed device 11′ changes over time to maximize the amount of kinetic energy of said air flow captured by said further first blade 14′.

It is preferable that said further first bladed device 11′ comprises further first guide rotation means 17′ for rotating said further first guide element 12′ in space.

With reference to said further first guide rotation means 17′, said further first guide rotation means 17′ can comprise a further first electro-mechanical actuator for receiving a signal sent by the logic control unit U and for rotating said further first guide element 12′ around the shaft 18A′ of said further first supporting means.

For example said further first electro-mechanical actuator can be a further stepping motor.

Furthermore, in the example being described, said further first guide rotation means 17′ are arranged around said shaft 18A′ of said further first supporting means and positioned on a further end portion of said first bracket S11′ of said further first supporting means.

Although not shown in the Figure, said further first guide rotation means 17′ are connected or fixed to a further first portion of the frame 100 of the wind apparatus, for example by means of a further first bar.

Said logic control unit U can be configured to send a signal to said further first guide rotation means 17′ for rotating said further first guide element 12′ in such a way that said further first guide element 12′ has an orientation equal to a stored predetermined orientation which is selected on the basis of the correspondence between the distance of said further first slider 13′ from an end point of said segment of said further first trajectory and a stored predetermined distance and on the correspondence between the calculated velocity of said further first blade and a stored predetermined velocity of said further first blade, so that the aerodynamic behaviour of said further first bladed device 11′ changes over time to further maximize the amount of kinetic energy of said air flow captured by said further first bladed 14′.

In the second embodiment being described, said first motion transmission mechanism comprises (shown in FIGS. 9A and 9B):
at least one further first rotating element 181′ connected to said further first slider 13′ of said further first bladed device 11′ in such a way that the movement of said further first slider 13′, due to the movement of said further first blade 14′ in said first direction or in said second direction, respectively causes rotation of said further first rotating element 181′ in a first direction or in a second direction, and
further first connecting means for connecting said further first rotating element 181′ to said first shaft A1, so that rotation of said further first rotating element 181′ in said first direction causes rotation of said first shaft A1 in said predetermined direction or that the rotation of said further first rotating element 181′ in said first direction and in said second direction causes the rotation of said first shaft A1 in said predetermined direction.

Said first wind system 1 (comprising said first bladed device 11 and said further first bladed device 11′) is configured to transfer said amount of kinetic energy to said first shaft A1, so that the kinetic energy of the air flow is transformed into rotational mechanical energy of said first shaft A1.

With reference to said further first connecting means, said further first connecting means comprise a rotating pulley P11′ with the same shaft 18A′ with which said further first rotating element 181′ rotates.

Said pulley P11′ is connected to a further pulley P12′ via a belt C12′, in which said further pulley P12′ is a freewheel pulley and rotates around said first axis A11.

In particular, when said further pulley P12′ rotates around said first axis A11 in said first direction it causes rotation of said first shaft A1 in said first direction (in the example which is described the first direction of the first shaft A1 coincides with the predetermined direction).

When said further pulley P12′ rotates around said first axis A11 in said second direction, said further pulley P12′ rotates idle with respect to said first shaft A1 and therefore does not exert any action on said first shaft A1.

In particular, when said further first slider 13′ (i.e. said further first rack) moves in a first direction, said further first rotating element 181′ causes rotation of said shaft 18A′ in a first direction.

The rotation of said shaft 18A′ causes the rotation of said pulley P11′ in a first direction and, through said belt C12′, the motion of pulley P11′ is transmitted to the further pulley P12′, so that said further pulley P12′ rotates around said first axis A11 in a first direction causing rotation of said first shaft A1 in its predetermined direction.

When said further first slider 13′ (i.e. said further first rack) moves in a second direction, opposite to said first direction, said further first rotating element 181′ causes rotation of said shaft 18A′ in a second direction.

The rotation of said shaft 18A′ causes the rotation of said pulley P11′ in a second direction and, through said belt C12′, the motion of pulley P11′ is transmitted to the further pulley P12′, so that said further pulley P12′ rotates around said first axis A11 in a second direction.

However, as mentioned above, in this case, said further pulley P12′ rotates idle with respect to said first shaft A1 and therefore does not affect the rotation of said first shaft A1.

In other words, said first shaft A1 rotates in its predetermined direction only when said further first slider 13′ moves in said first direction.

Furthermore, said first motion transmission mechanism further comprises connecting means for connecting the first bladed device 11 to the further first bladed device 11′ so that, when the first slider 13 of the first bladed device 11 moves in said first direction/second direction, the further first slider 13′ of the further first bladed device 11′ moves in said second direction/first direction.

In this case, said logic control unit U can be configured to send a signal to said further first blade rotation means 15′ to rotate said further first blade 14′ when the distance of said further first blade 14′ with respect to said end point of said segment of said further first trajectory is equal to a stored predetermined distance.

Furthermore, said logic control unit U can be configured to send a signal to said further first guide rotation means 17′ for rotating said further first guide element 12′, when the distance of said further first blade 14′ with respect to said end point of said segment of said further first trajectory is equal to a stored predetermined distance.

With reference to said connecting means for connecting the first bladed device 11 to the further first bladed device 11′, said connecting means for connecting the first bladed device 11 to the further first bladed device 11′ comprise:
a first pair of gear wheels for the first bladed device 11, comprising:
a first gear wheel R11 rotating with the shaft 18A passing through the holes of the two brackets S11, S12 mentioned above,
a second gearwheel R12 connected via a belt CR to said first gearwheel R11 in such a way that rotation of said first gear wheel R11 in a first direction/second direction causes rotation of said second gearwheel R12 in said first direction/second direction,
a further first pair of gear wheels for the further first bladed device 11′, comprising:
a first gearwheel R21 rotating with the further shaft 18A′ passing through the further holes of the two further brackets S11′, S12′ mentioned above, a second gearwheel R22, engaged with said first gearwheel R21,
a connecting shaft AC for connecting the second gear wheel R12 of the first pair of gear wheels and the second gear R22 of the further first pair of gear wheels such that rotation of the second gear wheel R12 of the first pair of gearwheels in said first direction/second direction causes rotation of the second gear wheel R22 of the further first pair of gear wheels in said first direction/second direction.

Since the gear wheels of the further first pair of gear wheels are engaged with each other, rotation of the second gear wheel R22 of the further first pair of gearwheels in said first direction/second direction causes rotation of the first gear wheel R21 of the same further first pair of gear wheels in said second direction/first direction.

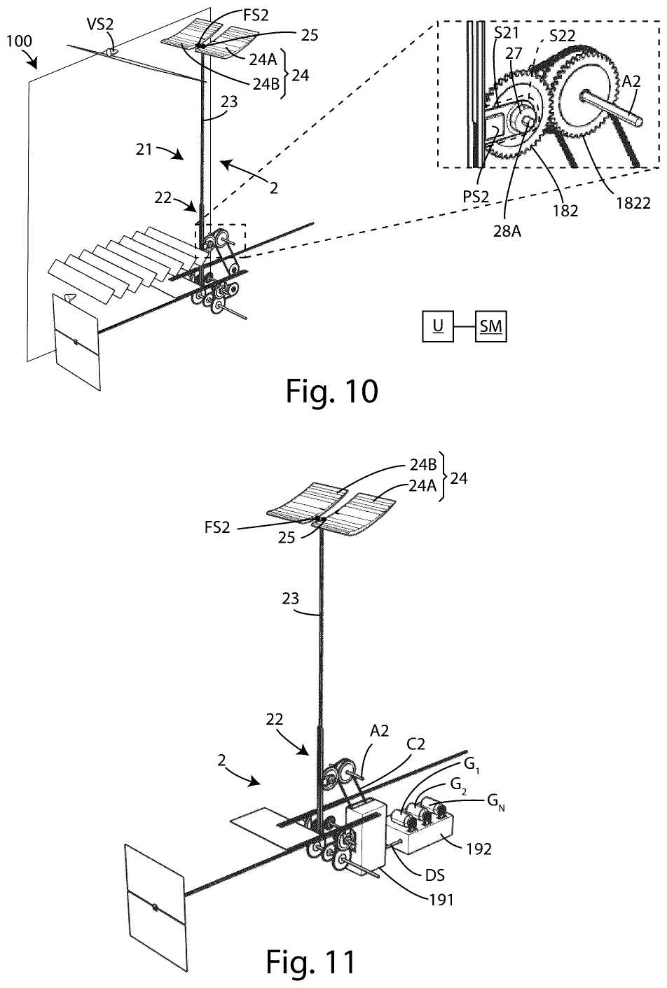

In a third embodiment shown in FIG. 10, said wind apparatus comprises a second wind system 2.

Said second wind system comprises a second bladed device 21 comprising:
a second guide element 22 defining a second trajectory comprising one or more segments, each of which is delimited by a first end point and a second end point,
a second slider 23 sliding on said second guide element 22 in a first direction and in second direction, opposite said first direction,
at least one second blade 24 orientable in space with respect to a direction of an air flow and constrained to said second slider 23 in such a way that, when said air flow incides on said second blade 24, said air flow moves said second blade 24 and the movement of said second blade 24 causes the movement of said second slider 23 along said second guide element 22 in said first direction or in said second direction, second blade rotation means 25 for rotating said second blade 24 in space with respect to said second slider 23.

With reference to said second guide element 22, in the example being described, said second guide element 22 has a rectilinear shape, so that each segment of said second trajectory is a rectilinear segment.

However, said second guide element 22 can have a shape other than the rectilinear shape, without departing from the scope of the invention.

With reference to said second slider 23, in the embodiment being described, said second slider 23 is a second rack.

With reference to said second blade 24, said second blade 24 can comprise at least a first part 24A and a second part 24B connected to each other.

Said second blade rotation means 25 are configured to rotate said first part 24A and said second part 24B of said second blade 24 independently on each other, so that an aerodynamic force acting on said second blade 24 is maximized along the same direction in which the second slider 23 moves along said second guide element 22 and the aerodynamic behaviour of said second bladed device 21 changes overtime to maximize the amount of kinetic energy captured by said second blade 24.

Said second blade 24 can have airfoil profile and said first part 24A and said second part 24B of said second blade 24 are movable between:
a first position, wherein said first part 24A and said second part 24B of said second blade 24 are rotated by said second blade rotation means 25 in such a way that said second blade 24 maximize said aerodynamic force in said first direction and that said aerodynamic force moves said second blade 24 in said first direction along said segment of said second trajectory, and
a second position, wherein said first part 24A and said second part 24B of said second blade 24 are rotated by said second blade rotation means 25 in such a way that said second blade 24 maximize said aerodynamic force in said second direction and that said aerodynamic force moves said second blade 24 in said second direction along said segment of said second trajectory.

The airfoil of the second blade 24 can be a symmetrical airfoil (such as NACA 0012) or an asymmetrical airfoil (such as NACA 64-415 AIRFOIL).

However, the second blade 24 can have any profile other than the airfoil.

For example, the second blade 24 can have the cross-sectional shape of an elliptical or a rectangle or a circular segment.

With reference to said second blade rotation means 25, said second blade rotation means 25 can comprise a second electro-mechanical actuator configured to receive a signal from the logic control unit U and to rotate said second blade 24.

In the embodiment being described, said second blade rotation means 25 comprise a second hinge connected to the first part 24A and to the second part 24B of the second blade 24 for rotating said first part 24A and said second part 24B, wherein said second hinge is an electric hinge configured to be controlled by said logic control unit U. Consequently said second hinge is provided with a control module for receiving a signal sent by the logic control unit U and for rotating said second blade 24.

Said second wind system 2 comprises at least one second position sensor PS2 for detecting the position of said second blade 24.

The expression “position of the second blade” means the position of the point where said second blade 24 is constrained to said second slider 23.

The position of the second blade 24 can coincide with the position of the first slider 23 with respect to a reference on the second bladed device 21.

In the example described, said second position sensor is preferably included in said second bladed device 21.

With reference to said second position sensor PS2, said second position sensor PS2 is positioned on second supporting means for supporting said second guide rotation means 27 (mentioned later), wherein said second supporting means are connected to the second guide element 22.

In particular, said second supporting means comprise a first bracket S21 and a second bracket S22, facing the first bracket S21, and said second position sensor PS2 is arranged on an end portion of said first bracket S21.

Said second supporting means comprise a shaft 28A which passes through a respective hole of each bracket S21, S22.

The second bracket S22 of said second supporting means is represented by a dashed line in the enlargement of FIG. 10, because it is covered by the second rotating element 182 which also covers the pulley P21 (in particular the second bracket S22 is positioned between said second rotating element 182 and said pulley P21 rotating with the shaft 28A of said second supporting means), wherein said second rotating element 182 and said pulley P21 are described later.

With reference to the third embodiment, the following data are stored in said storage means SM:
the position of each end point of each segment of said second trajectory (i.e. the position of the first end point and the position of the second end point of each segment of said second trajectory),
for each end point of each segment of said second trajectory a plurality of predetermined distances between said second slider 23 and said end point, wherein each predetermined distance of said plurality of predetermined distances is associated with a respective predetermined velocity of said second bladed 24, a respective predetermined orientation of said second bladed 24 and a respective predetermined orientation of a segment of said second trajectory.

Said segment may be the segment on which said second blade 24 moves to reach an end point (which may be the first end point or the second end point) or the segment towards which said second blade 24 moves, i.e. the segment arranged in succession to the segment on which said second blade 24 moves.

In the third embodiment being described, said logic control unit U can be configured to:
acquire over time a plurality of positions of said second slider 23, through said second position sensor PS2,
calculate:
a first position difference between a position of said second slider 23 acquired in a time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said second trajectory towards which the second blade 24 moves, wherein said position is stored in said storage means SM, and the position of said second slider 23,
the velocity of said second blade 24 with an intensity or module equal to the ratio between said first position difference and said time difference, and
the distance of said second blade 24 with respect to said end point of said segment of said second trajectory equal to the result of said second position difference,
when said distance (i.e. the distance of said second blade 24 with respect to said end point of said segment of said second trajectory) is equal to a predetermined distance of said plurality of predetermined distances, send a signal to said second blade rotation means 25 for rotating said second blade 24 in such a way that said second blade 24 has an orientation equal to a stored predetermined orientation which is selected on the basis of the correspondence between the distance of said second slider 23 from an end point of said segment of said second trajectory and a stored predetermined distance and on the correspondence between the calculated velocity of said second blade and a stored predetermined velocity of said second blade, so that the aerodynamic behaviour of said second bladed device 21 changes over time to maximize the amount of kinetic energy of said airflow captured by said second blade 24.

It is preferable that said second bladed device 21 comprises second guide rotation means 27 for rotating said second guide element 22 in space.

With reference to said second guide rotation means 27, said second guide rotation means 27 can comprise a second electro-mechanical actuator for receiving a signal sent by the logic control unit U and for rotating said second guide element 22 around the shaft 28A of said second support means.

For example said second electro-mechanical actuator can be a second stepping motor.

Furthermore, in the example being described, said second guide rotation means 27 are arranged around said shaft 28A of said second supporting means and positioned on a further end portion of said further first bracket S21. Although not shown in the figure, said second guide rotation means 27 are connected or fixed to a second portion of the frame 100 of the wind apparatus, for example by means of a second bar.

Said logic control unit U can be configured to send a signal to said second guide rotation means 27 for rotating said second guide element 22 in such a way that said second guide element 22 has an orientation equal to a stored predetermined orientation which is selected on the basis of the correspondence between the distance of said second slider 23 from an end point of said segment of said second trajectory and a stored predetermined distance and on the correspondence between the calculated velocity of said second blade and a stored predetermined velocity of said second blade, so that the aerodynamic behaviour of said second bladed device 21 changes over time to further maximize the amount of kinetic energy of said air flow captured by said second blade 24.

Said second wind system 2 comprises:
at least one second speed sensor VS2 for detecting the velocity of the air flow incident on said second blade 24,
at least one second force sensor FS2 for detecting a force acting on said second blade 24.

The following data are stored in said storage means SM:
a plurality of predetermined air flow velocities,
a plurality of predetermined forces, wherein each of predetermined force of said plurality of predetermined forces is associated with a respective predetermined air flow velocity of said plurality of predetermined airflow velocities, a respective predetermined velocity of said second slider 23, a respective predetermined orientation of said second blade 24 and a respective predetermined orientation of said segment of said second trajectory on which said second blade 24 moves to reach an end point.
   Said logic control unit U can be configured to:
acquire a plurality of airflow velocities overtime, through said second velocity sensor VS2,
acquire a plurality of forces acting on said second blade 24 overtime, through said second force sensor FS2,
compare
the velocity of the air flow detected through said second velocity sensor VS2 with each stored predetermined air flow velocity in said storage means SM, and
the velocity of said second blade 24 with each predetermined velocity of said second blade stored in said storage means SM,
to obtain a predetermined force selected on the basis of the correspondence between the acquired air flow velocity and a stored predetermined air flow velocity and of the correspondence between the calculated velocity of said second blade and a stored predetermined velocity of said second blade,
compare each acquired force with said predetermined force, if an acquired force is less than said predetermined force, send a signal to said second blade rotation means 25 for rotating said second blade 24 in such a way that said second blade 24 has an orientation equal to a stored predetermined orientation which is selected on the basis of said predetermined force.

Said logic control unit U can be configured to send a signal to said guide rotation means 27 for rotating said second guide element 22 in such a way that said second guide element 22 has an orientation equal to a stored predetermined orientation which is selected on the basis of the correspondence between the acquired air flow velocity and a stored predetermined air flow and on the correspondence between the calculated velocity of said second blade and a stored predetermined velocity of said second blade.

Said wind system 2 comprises:
a second motion transmission mechanism comprising:
at least one second rotating element 182 connected to said second slider 23 in such a way that the movement of said second slider 23, due to the movement of said second blade 24 in said first direction or in said second direction, causes respectively the rotation of said second rotating element 182 in a fist direction or in a second direction,
a second shaft A2 having a rotation axis A22 and configured to rotate around said rotation axis A22 in a predetermined direction,
second connecting means for connecting said second rotating element 182 to said second shaft A2, in such a way that the rotation of said second rotating element 182 in said first direction causes the rotation of said second shaft A2 in said predetermined direction or that the rotation of said second rotating element 182 in said first direction and said second direction causes the rotation of said second shaft A2 in said predetermined direction.

In the example being described, the rotation of the second rotating element 182 causes the rotation of the second shaft A2 in the predetermined direction both when said second rotating element 182 rotates in the first direction and when it rotates in the second direction.

Said second wind system 2 is configured to transfer said quantity of kinetic energy to said second shaft A2, so that the kinetic energy of the air flow is transformed into rotational mechanical energy of said second shaft A2.

Regardless of whether the second rotating element 182 rotates in a first direction or in a second direction, the second shaft A2 connected to said second rotating element 182 rotates in only one predetermined direction.

In the example being described, with reference to said second motion transmission mechanism, said second rotating element 182 is a second gear wheel which is engaged with said second slider 23 (i.e. said second rack) and rotating with the shaft 28A of said second supporting means.

Said second rotating element 182 is arranged between said two brackets S21, S22.

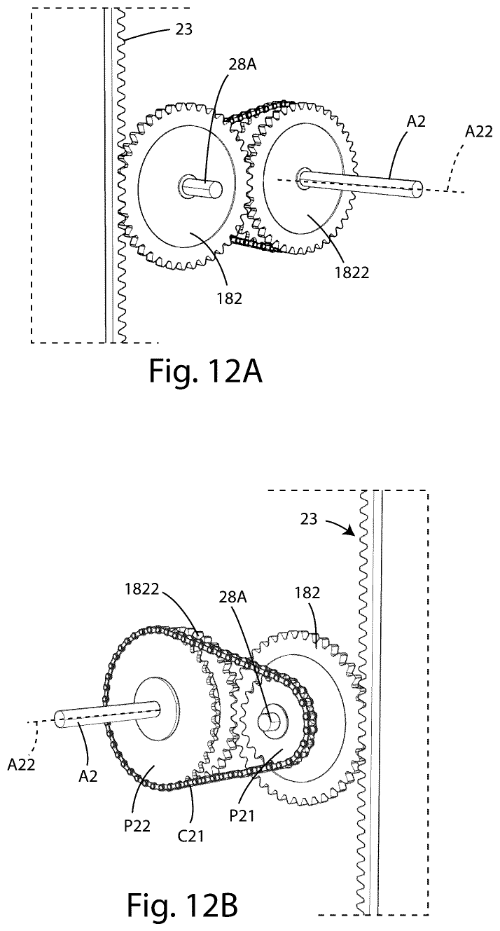

With reference to said second connecting means, said second connecting means can comprise (FIGS. 12A and 12B):
a rotating pulley P21 with the same shaft 28A with which said second rotating element 182 rotates,
a further pulley P22 connected to said pulley P21 via a belt C21, wherein said further pulley P22 is a freewheel pulley and rotates around said second axis A22,
a further gear wheel 1822 engaged with said second rotating element 182 (i.e. said second gear wheel) and rotating about said second axis A22, wherein said further gear wheel 1822 is a freewheel gear wheel.

When said second slider 23 (i.e. said second rack) moves in a first direction, said second rotating element 182 causes rotation of said shaft 28A of said second supporting means in a first direction.

The rotation of said shaft 28A of said second supporting means causes the rotation of said pulley P21 in a first direction and, through said belt C21, the motion of pulley P21 is transmitted to the further pulley P22, so that said further pulley P22 rotates about said second axis A22 in a first direction, causing rotation of said second shaft A2 in said first direction (in the example being described the first direction of the second shaft A2 coincides with the predetermined direction).

Since the further gear wheel 1822 is engaged with the second rotating element 182, said further gear wheel 1822 rotates idle around said second shaft A2 in said second direction and therefore does not exert any action on said second shaft A2.

When said second slider 23 (i.e. said second rack) moves in a second direction, opposite to said first direction, said second rotating element 182 causes rotation of said shaft 28A of said second supporting means in a second direction.

The rotation of said shaft 28A of said second supporting means causes the rotation of said pulley P21 in a second direction and, through said belt C21, the motion of the pulley P21 is transmitted to the further pulley P22, so that said further pulley P22 rotates idle about said second shaft A2 in a second direction, and does not affect the rotation of said second shaft A2.

Since the further gear wheel 1822 is engaged with the second rotating element 182, said further gear wheel 1822 rotates about said second axis A22 in said first direction, causing rotation of said second shaft A2 in said first direction (in the example being described the first direction of the second shaft A2 coincides with the predetermined direction).

In other words, said second shaft A2 rotates in its predetermined direction both when said second slider 23 moves in said first direction and when it moves in said second direction.

Advantageously, said second blade 24 can capture kinetic energy even when the direction of the air flow changes rapidly over time from the first direction to the second direction and vice versa.

Said motion transmission mechanism for transmitting motion to said drive shaft DS comprises connecting means for connecting said second shaft A2 to said drive shaft DS, so that the rotation of said first shaft A1 and the rotation of said second shaft A2 cause the rotation of said drive shaft DS.

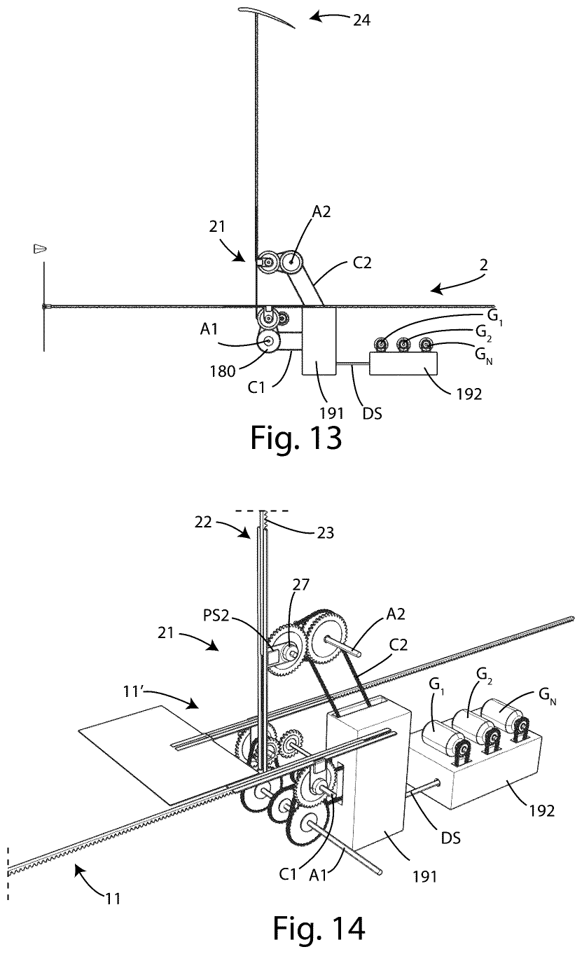

With reference to said connecting means for connecting said second shaft A2 to said drive shaft DS, said connecting means for connecting said second shaft A2 to said drive shaft DS comprise (FIGS. 13 to 15):
a second input shaft (not shown),
a gear wheel (not shown) rotating with said second input shaft,
a second output shaft (not shown) connected to said drive shaft DS, and
a gear wheel 1800 rotating with said second shaft A2 and connected, by means of a belt C2, to said gear wheel rotating with said second input shaft.

In particular, the second input shaft, the gear wheel rotating with said second input shaft and the second output shaft are arranged inside said gearbox 191, while the gear wheel 1800 rotating with said second shaft A2 is external to said gearbox 191.

The second output shaft is connected to the drive shaft DS via a second mechanical element (not shown) which is arranged inside the gearbox 191.

Said second mechanical element can be a second friction element, for example a second friction gearwheel.

The gearbox 191 further comprises a second plurality of gears for connecting said second input shaft to said second output shaft so as to vary the transmission ratio between said second input shaft and said second output shaft.

At least one gear of said second plurality of gears can be an electromechanical device configured to receive a signal from the logic control unit U to vary said transmission ratio.

Accordingly, the logic control unit U can be configured to send a signal to said at least one gear of said second plurality of gears to vary said transmission ratio.

In other words, the motion of the second shaft A2 is transmitted via the belt C2 to the second input shaft inside the gearbox 191, and via said second plurality of gears to the second output shaft and finally via the second mechanical element from second output shaft to drive shaft DS.

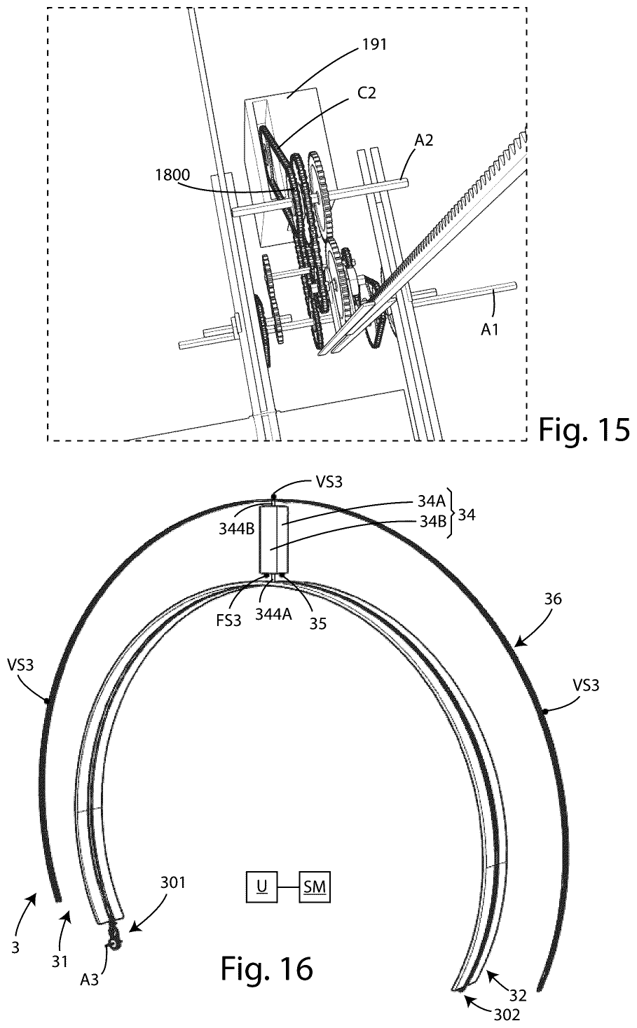

FIG. 16 shows a fourth embodiment of the wind apparatus.

Said wind apparatus comprises a third wind system 3 and said third wind system 3 comprises a third bladed device 31.

Said third bladed device 31 comprises:
a third guide element 32 having a curvilinear or substantial curvilinear shape defining a third trajectory comprising a plurality of segments, wherein each segment of said plurality of segments is delimited by a first end point and a second end point,
a third slider 33 sliding on said third guide element 32 in a first direction and in a second direction, opposite to said first direction,
at least one third blade 34 orientable in space with respect to a direction of an air flow and constrained to said third slider 33 in such a way that, when said air flow incides on said third blade 34, said air flow moves said third blade 34 and the movement of said third blade 34 causes the movement of said third slider 33 along said third guide element 32 in said first direction or in said second direction,
third blade rotation means 35 for rotating said third blade 34 in space with respect to said third slider 33.

With reference to said third guide element 32, said plurality of segments can comprise one or more rectilinear segments and one or more curvilinear segments or only curvilinear segments.

In the embodiment being described, said third bladed device 31 comprises a supporting element 36 to support the sliding of said third blade 34 on said third guide element 32.

In particular, said third blade 34 is arranged between said third guide element 32 and said supporting element 36 and is provided with a first protrusion 344A to be engaged with the third slider 33 (so as to be constrained to said third slider 33) and with a second protrusion 344B sliding in a groove of said supporting element 36.

However, said supporting element 36 is not necessary.

In fact, said third bladed device 31 can be without said supporting element 36, without thereby departing from the scope of the invention.

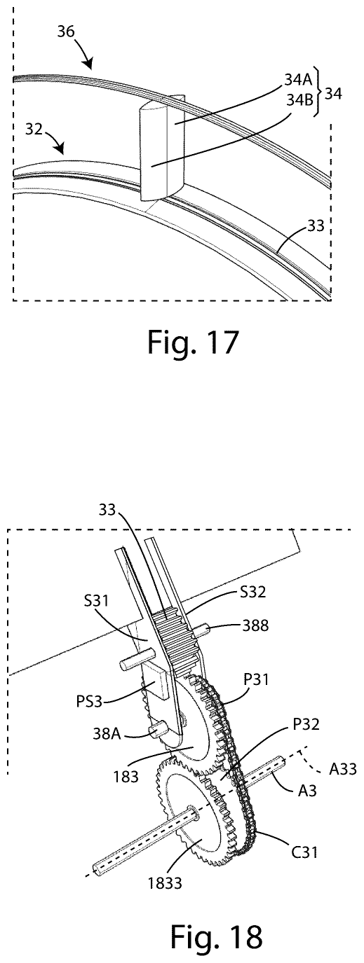

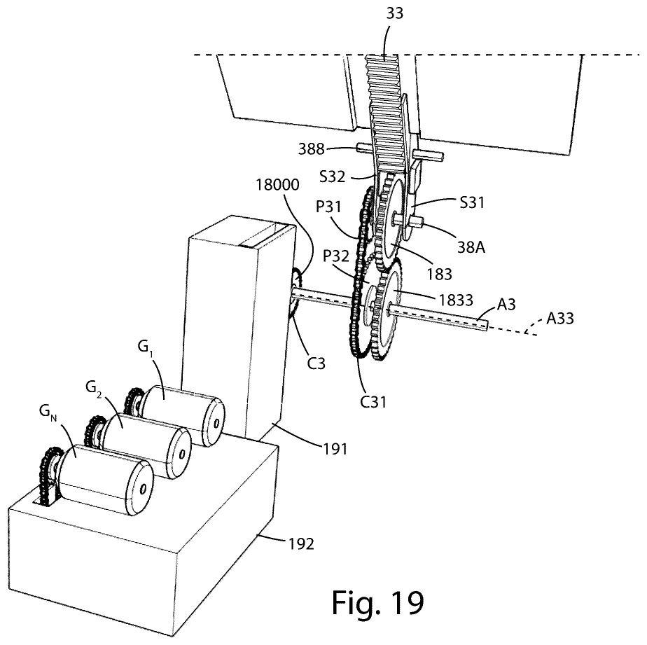

With reference to said third slider 33 (shown in particular in FIG. 17), in the embodiment being described, said third slider 33 is a toothed belt.

Said toothed belt slides inside said third guide element 32 through two pulleys 301, 302, each of which is positioned at a respective end portion of said third guide element 32.

In other words, a first pulley 301 is positioned at a first end portion and a second pulley 302 is positioned at a second end portion of the third guide element 32, so that the movement of the third blade 34 causes rotation of said toothed belt on said pulleys 301, 302 in said first direction or in said second direction.

As already mentioned, the third blade 34 comprises a first protrusion 344A so that the third blade 34 is constrained to said toothed belt.

With reference to the third blade 34, said third blade 34 comprises at least a first part 34A and a second part 34B connected to each other.

Said third blade rotation means 35 are configured to rotate said first part 34A and said second part 34B of said third blade 34 independently on each other, so that an aerodynamic force acting on said third blade 34 is maximized along the same direction in which the third slider 33 moves along said third guide element 32, and the aerodynamic behaviour of said third bladed device 31 changes over time to maximize the amount of the kinetic energy captured by said third blade 34.

In particular, said third blade 34 can have an airfoil profile and said first part 34A and said second part 34B of said third blade 34 are movable between:
a first position, wherein said first part 34A and said second part 34B of said third blade 34 are rotated by said third blade rotation means 35 in such a way that said third blade 34 maximizes the aerodynamic force in said first direction and that said aerodynamic force moves said third blade 34 in said first direction along said segment of said third trajectory, and
a second position, wherein said first part 34A and said second part 34B of said third blade 34 are rotated by said third blade rotation means 35 in such a way that said third blade 34 maximizes the aerodynamic force in said second direction and that said aerodynamic force moves said third blade 34 in said second direction along said segment of said third trajectory.

Said third wind system comprises at least one third position sensor PS3 for detecting the position of said third blade 34 (shown in particular in FIG. 18).

The expression “position of the third blade” means the position of the point where said third blade 34 is constrained to said third slider 33.

The position of the third blade 34 can coincide with the position of the third slider 33 with respect to a reference on the third bladed device 31.

In the embodiment being described, said third position sensor PS3 is preferably included in said third bladed device 31.

With reference to said third position sensor PS3, said third position sensor PS3 is positioned on third supporting means for supporting said first pulley 301 and a third rotating element 183 forming part of third connecting means for connecting said third rotating element 183 to a third shaft A3 (mentioned later), wherein said third supporting means are connected or fixed to the third guide element 32.

In particular, said third supporting means comprise a first bracket S31 and a second bracket S32, facing the first bracket S31, and said third position sensor PS3 is arranged on a portion of said first bracket S31.

Said third support means comprise a shaft 38A (for the rotation of said third rotating element 183) which passes through a respective hole of each bracket S31, S32 of said third supporting means, as well as a further shaft 388 (for the rotation of said first pulley 301) which passes through a respective further hole of each bracket S31, S32 of said third supporting means.

The following data are further stored in said storage means SM:
the position of each end point of each segment of said third trajectory (i.e. the position of the first end point and the position of the second end point of each segment of said third trajectory),
for each end point of each segment of said third trajectory a plurality of predetermined distances between said third slider 33 and said end point, wherein each predetermined distance of said plurality of predetermined distances is associated with a respective predetermined velocity of said third blade 34, and a respective predetermined orientation of said third blade 34.
   Said logic control unit U is configured to:
acquire a plurality of position values associated with said third slider 33 over time, through said third position sensor PS3,
calculate:
a first position difference between a position of said third slider 33 acquired in a time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said third trajectory towards which the third blade 34 moves, wherein said position is stored in said storage means SM, and the position of said third slider 33,
the velocity of said third blade 34 with an intensity or module equal to the ratio between said first position difference and said time difference, and
the distance of said third blade 34 with respect to said end point of said segment of said third trajectory equal to the result of said second position difference,
when said distance of said third blade 34 (with respect to said end point of said segment of said third trajectory) is equal to a predetermined distance of said plurality of predetermined distances, send a signal to said third blade rotation means 35 for rotating said third blade 34 in such a way that said third blade 34 has an orientation equal to a stored predetermined orientation which is selected on the basis of the correspondence between the distance of said third slider 33 from an end point of said segment of said third trajectory and a stored predetermined distance and on the basis of the calculated velocity of said third blade and a stored predetermined velocity of said third blade, so that the aerodynamic behaviour of said third bladed device 31 changes over time to maximize the amount of kinetic energy of said air flow captured by said third blade 34.

Said third wind system 3 comprises:
at least one third velocity sensor VS3 for detecting the velocity of the airflow incident on said third blade 34, and
at least one third force sensor FS3 for detecting a force acting on said third blade 34.

In particular, in the example being described, said third wind system comprises three velocity sensors VS3, arranged along said supporting element 36 in such a way as to be spaced apart from each other, as shown in FIG. 16.

The following data are stored in said storage means SM:
a plurality of predetermined air flow velocities,
a plurality of predetermined forces, wherein each predetermined force of said predetermined forces is associated with a respective predetermined air flow velocity of said predetermined air flow velocities, a respective predetermined velocity of said third slider 33, a respective predetermined orientation of said third blade 34.
   Said logic control unit U is configured to:
acquire a plurality of air flow velocities over time, through said third velocity sensor VS3,
acquire a plurality of forces acting on said third blade 34 over time, through said third force sensor FS3,
compare
the velocity of the air flow detected through said third velocity sensor VS3 with each predetermined air flow velocity stored in said storage means SM, and
the velocity of said third blade 34 with each predetermined velocity of said third blade stored in said storage means SM,
to obtain a predetermined force selected on the basis of the correspondence between the acquired air flow velocity and a stored predetermined airflow velocity and on the correspondence between the calculated velocity of said third blade and a stored predetermined velocity of said third blade,
compare each acquired force with said predetermined force, if an acquired force is less than said predetermined force, send a signal to said blade rotation means 35 for rotating said third blade 34 in such a way that said third blade 34 has an orientation equal to a stored predetermined orientation which is selected on the basis of said predetermined force.

Said third wind system 3 comprises a third motion transmission mechanism.

Said third motion transmission mechanism comprises (FIG. 18):
at least one third rotating element 183 connected to said third slider 33 (i.e. said toothed belt) in such a way that the movement of said third slider 33, due to the movement of said third blade 34 in said first direction or in said second direction, causes respectively the rotation of said third rotating element 183 in a first direction or in a second direction,
a third shaft A3 having a rotation axis A33 and configured to rotate around said rotation axis A33 in a predetermined direction,
third connecting means for connecting said third rotating element 183 and said third shaft A3, in such a way that the rotation of said third rotating element 183 in said first direction and in said second direction causes the rotation of said third shaft A33 in said predetermined direction.

Said third wind system 3 is configured to transfer said amount of kinetic energy to said third shaft A3, so that the kinetic energy of the air flow is transformed in rotational mechanical energy of said third shaft A3.

In the example which is described, with reference to said third motion transmission mechanism, said third rotating element 183 is a third gear wheel which is engaged with said third slider 33 (i.e. said toothed belt) and rotates with the shaft 38A of said third supporting means.

Said third rotating element 183 is arranged between said two brackets S31, S32.

With reference to said third connecting means, said third connecting means can comprise:
a pulley P31 rotating with the same shaft 38A with which said third rotating element 183 rotates,
a further pulley P32 connected to said pulley P31 via a belt C31, wherein said further pulley P32 is a freewheel pulley and rotates around said third axis A33.
a further gearwheel 1833 engaged with said third rotating element 183 (i.e. said third gear wheel 183) and rotating about said third axis A33, wherein said further gear wheel 1833 is a freewheel gear wheel.

When said third slider 33 (i.e. said toothed belt) moves in a first direction, said third rotating element 183 causes rotation of said shaft 38A of said third support means in a first direction.

The rotation of said shaft 38A of said third supporting means causes the rotation of said pulley P31 in a first direction and, through said belt C31, the motion of the pulley P31 is transmitted to the further pulley P32, so that said further pulley P32 rotates around said third axis A33 in a first direction, causing rotation of said third shaft A3 in said first direction (in the example being described the first direction of the third shaft A3 coincides with the predetermined direction).

Since the further gear wheel 1833 is engaged with the third rotating element 183, said further gear wheel 1833 rotates idle around said third shaft A3 in said second direction and therefore does not exert any action on said third shaft A3.

When said third slider 33 (i.e. said third toothed belt) moves in a second direction, opposite to said first direction, said third rotating element 183 causes rotation of said shaft 38A of said third supporting means in a second direction.

The rotation of said shaft 38A of said third supporting means causes the rotation of said pulley P31 in a second direction and, through said belt C31, the motion of the pulley P31 is transmitted to the further pulley P32, so that said further pulley P32 rotates idle with respect to said third shaft A3 and does not affect the rotation of said third shaft A3.

Since the further gear wheel 1833 is engaged with the third rotating element 183, said further gearwheel 1833 rotates about said third axis A33 in said first direction causing rotation of said third shaft A3 in said first direction (in the example being described the first direction of the third shaft A3 coincides with the predetermined direction).

In other words, said third shaft A3 rotates in its predetermined direction both when said third slider 33 moves in said first direction and when it moves in said second direction.

Advantageously, said third blade 34 can capture kinetic energy even when the direction of the air flow changes rapidly over time from the first direction to the second direction and vice versa.

Said motion transmission mechanism for transmitting motion to said drive shaft DS comprises connecting means for connecting said third shaft A3 to said drive shaft DS, so that the rotation of said first shaft A1, of said second shaft A2 and of said third shaft A3 cause rotation of said drive shaft DS.

With reference to said connecting means for connecting said third shaft A3 to said drive shaft DS, said connecting means for connecting said third shaft A3 to said drive shaft DS comprise:
a third input shaft (not shown),
a gearwheel (not shown) rotating with said third input shaft,
a third output shaft (not shown) connected to said drive shaft DS, and
a gearwheel 18000 rotating with said third shaft A3 and connected, by means of a belt C3, to said gear wheel rotating with said third input shaft.

In particular, the third input shaft, the gearwheel rotating with said third input shaft and the third output shaft are arranged inside said gearbox 191, while the gear wheel 18000 rotating with said third shaft A3 is external to said 191 gearbox.

The third output shaft is connected to the drive shaft DS via a third mechanical element (not shown) which is arranged inside the gearbox 191.

Said third mechanical element can be a third friction element, for example a third friction gearwheel.

The gearbox 191 further comprises a third plurality of mechanisms for connecting said third input shaft to said third output shaft so as to vary the transmission ratio between said third input shaft and said third output shaft.

At least one mechanism of said third plurality of mechanisms can be an electromechanical device configured to receive a signal from the logic control unit U to vary said transmission ratio.

Accordingly, the logic control unit U can be configured to send a signal to said at least one mechanism of said third plurality of mechanisms to vary said transmission ratio.

In other words, the motion of the third shaft A3 is transmitted via the belt C3 to the third input shaft inside the gearbox 191, and via said third plurality of mechanisms to the third output shaft and finally, via the third mechanical element, from the third output shaft to the drive shaft DS.

Said wind apparatus comprises a motion transmission mechanism for transmitting the motion from said drive shaft DS to at least one respective shaft of an electric energy generator G₁, G₂ . . . G_{N} of a plurality of electric energy generators G₁, G₂ . . . G_{N}.

One or more further bladed devices (such as for example the first bladed device, the further first bladed device, and the second bladed device described above) can be connected to said electric energy generators G₁, G₂ . . . G_{N}.

In the example being described, said plurality of electric energy generators is the same plurality of electric energy generators described above for the other wind systems and said motion transmission mechanism for transmitting the motion from said drive shaft DS to at least one shaft of an electric energy generator G₁, G₂ . . . G_{N} is the same motion transmission mechanism described above for other wind systems.

As already mentioned, with reference to the velocity referred to the blades, said velocity is a vector quantity and is therefore defined by at least three parameters: the modulus or intensity, the direction and the orientation.

Therefore, in description, the terms “module” and “intensity” are used interchangeably.

Advantages

Advantageously, the wind apparatus object of the invention allows to capture a quantity of kinetic energy associated with an air flow even when the intensity and/or direction of said air flow changes/change rapidly over time.

A further advantage is given by the possibility of shaping and dimensioning said wind apparatus (and consequently each bladed device included in said wind apparatus) on the basis of the site where said wind apparatus is to be positioned.

The present invention has been described for illustrative, but not limitative purposes, according to its preferred embodiments, but it is to be understood that variations and/or modifications can be carried out by a skilled in the art, without departing from the scope thereof, as defined according to enclosed claims.

1. Wind apparatus comprising:
a first wind system comprising:
a first bladed device comprising:
a first guide element defining a first trajectory comprising one or more segments, each of which is delimited by a first end point and a second end point,
a first slider sliding on said first guide element in a first direction and in a second direction, opposite to said first direction,
at least one first blade orientable in space with respect to a direction of an air flow and constrained to said first slider in such a way that, when said air flow incised on said first blade, said air flow moves said first blade and the movement of said first blade causes the movement of said first slider along said first guide element in said first direction or in said second direction,
first blade rotation means for rotating said first blade in space with respect to said first slider, so as to change an angle between said first blade and the direction of said air flow,
at least one first position sensor for detecting the position of said first blade,
storage means in which the following data are stored:
the position of each end point of each segment of said first trajectory,
for each end point of each segment of said first trajectory a plurality of predetermined distances between said first slider and said end point, wherein each predetermined distance of said plurality of predetermined distances is associated with a respective predetermined velocity of said first blade, with a respective predetermined orientation of said first blade and with a respective predetermined orientation of a segment of said first trajectory;
a logic control unit configured to:
acquire over time a plurality of positions of said first slider, through said first position sensor,
calculate:
a first position difference between a position of said first slider acquired in a time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said first trajectory towards which said first blade moves, wherein said position is stored in said storage means, and the position of said first slider,
the velocity of said first blade with a module equal to a ratio between said first position difference and said time difference, and
the distance of said first blade with respect to said end point of said segment of said first trajectory equal to a result of said second position difference, and
when said distance is equal to a predetermined distance of said plurality of predetermined distances, send a signal to said first blade rotation means for rotating said first blade in such a way that said first blade has an orientation equal to a stored predetermined orientation which is selected on the basis of a correspondence between the distance of said first slider from an end point of said segment of said first trajectory and a predetermined distance stored and the correspondence between a calculated velocity of said first blade and a stored predetermined velocity of said first blade, so that a aerodynamic behaviour of said first bladed device changes over time to maximize an amount of kinetic energy of said air flow captured by said first blade.

2. Wind apparatus according to claim 1, wherein said first bladed device comprises first guide rotation means for rotating said first guide element in space, wherein
said logic control unit is configured to send a signal to said first rotation means for rotating said first guide element in such a way that said first guide element has an orientation equal to a stored predetermined orientation which is selected on the basis of the correspondence between the distance of said first slider from an end point of said segment of said first trajectory and a stored predetermined distance and the correspondence between the calculated velocity of said first blade and a stored predetermined velocity of said first blade, so that the aerodynamic behaviour of said first bladed device changes over time to further maximize the amount of kinetic energy of said air flow captured by said first blade.

3. Wind apparatus according to claim 1, wherein said first wind system comprises:
at least one first velocity sensor for detecting the velocity of the air flow incident on said first blade,
at least one first force sensor for detecting a force acting on said first blade;
wherein the following data are stored in said storage means:
a plurality of predetermined air flow velocities, and
a plurality of predetermined forces, wherein each predetermined force of said plurality of predetermined forces is associated with a respective predetermined air flow velocity of said plurality of predetermined air flow velocities, a respective predetermined velocity of said first slider, a respective predetermined orientation of said first blade and a respective predetermined orientation of said segment of said first trajectory on which said first blade moves to reach an end point,
wherein said logic control unit is configured to:
acquire a plurality of velocities of the air flow over time, through said first velocity sensor,
acquire a plurality of forces acting on said first blade over time, through said first force sensor,
compare the velocity of the air flow detected through said first velocity sensor with each predetermined air flow velocity stored in said storage means, and
the velocity of said first blade with each predetermined velocity of said first blade stored in said storage means,
to obtain a predetermined force selected on the basis of the correspondence between the acquired air flow velocity and a stored predetermined air flow velocity and of the correspondence between the calculated velocity of said first blade and a stored predetermined velocity of said first blade,
compare each acquired force with said predetermined force, and
if an acquired force is less than said predetermined force, send a signal to said first blade rotation means to rotate said first blade in such a way that said first blade has an orientation equal to a stored predetermined orientation which is selected on the basis of said predetermined force.

4. Wind apparatus according to claim 2, wherein said logic control unit is configured to send a signal to said first guide rotation means to rotate said first guide element so that said first guide element has an orientation equal to a stored predetermined orientation which is selected on the basis of the correspondence between the acquired air flow velocity and a stored predetermined air flow velocity and the correspondence between the calculated velocity of said first blade and a stored predetermined velocity of said first blade.

5. Wind apparatus according to claim 3, wherein said first wind system comprises:
a first motion transmission mechanism comprising:
at least one a first rotating element connected to said first slider in such a way that the movement of said first slider, due to the movement of said first blade in said first direction or in said second direction, causes respectively the rotation of said first rotating element in a first direction or in a second direction,
a first shaft having a rotation axis and configured to rotate around said rotation axis in a predetermined direction, and
first connecting means for connecting said first rotating element to said first shaft, in such a way that the rotation of said first rotating element in said first direction causes the rotation of said first shaft in said predetermined direction or that the rotation of said first rotating element in said first direction and in said second direction causes the rotation of said first shaft in said predetermined direction,
wherein said first wind system is configured to transfer said amount of kinetic energy to said first shaft, so that the kinetic energy of the air flow is transformed in rotation mechanical energy of said first shaft.

6. Wind apparatus according to claim 5, wherein said wind apparatus comprises:
a drive shaft,
a motion transmission mechanism for transmitting the motion to said drive shaft comprising:
connecting means for connecting said first shaft to said drive shaft, so that the rotation of said first shaft causes the rotation of said drive shaft.

7. Wind apparatus according to claim 6, wherein said wind apparatus comprises:
a plurality of electric energy generators to generate electric energy, wherein each electric energy generator of said plurality of electric energy comprises a respective shaft and one or more shafts of respective electric energy generators of said plurality of electric energy generators are connected to said drive shaft,
a motion transmission mechanism for transmitting motion from said drive shaft to at least one respective shaft of an electric energy generator, comprising:
connecting means for connecting or disconnecting said drive shaft to or from one or more respective shafts of electric energy generators of said plurality of electric energy generators,
wherein the following data are stored in said storage means:
a plurality of predetermined power values,
a respective predetermined number of electric energy generators is associated with each predetermined power value of said plurality of predetermined power values,
wherein said logic control unit is configured to:
calculate a power value starting from the force acquired through said first force sensor and from the calculated velocity of said first blade and from the number of said one or more electric energy generators connected to said drive shaft,
compare said power value with each predetermined power value to determine the predetermined number of electric energy generators associated with said predetermined power value,
compare the number of electric energy generators connected to said drive shaft with said predetermined number of electric energy generators,
if the number of electric energy generators connected to said drive shaft is less than said predetermined number of electric energy generators,
calculate a difference between said predetermined number of electric energy generators and said number of electric energy generators and the result of said difference is the number of electric energy generators to be connected to said drive shaft, and
send a control signal to said connecting means containing an information concerning the result of said difference to connect a respective number of electric energy generators to said drive shaft,
if the number of electric energy generators connected to said drive shaft is greater than said predetermined number of electric energy generators,
calculate a difference between said number of electric energy generators and said predetermined number of electric energy generators and the result of said difference is the number of electric energy generators to be disconnected from said drive shaft, and
send a control signal to said connecting means containing an information concerning the result of said difference to disconnect a respective number of electric energy generators from said drive shaft.

8. Wind apparatus according to claim 5, wherein
said first wind system comprises a further first bladed device,
wherein
said further first bladed device comprises:
a further first guide element defining a further first trajectory comprising one or more segments, each of which is delimited by a first end point and a second end point,
a further first slider sliding on said further first guide element in a first direction and in a second direction, opposite to said first direction,
at least one a further first blade orientable in space with respect to a direction of said air flow and constrained to said further first slider in such a way that, when said air flow incides on said further first blade, the movement of said further first blade causes the movement of said further first slider along said further first guide element in said first direction or in said second direction,
further first blade rotation means for rotating said further first blade in space with respect to said further first slider,
wherein said first wind system comprises:
a further first position sensor for detecting the position of said further first blade;
wherein the following data are further stored in said storage means:
the position of each end point of each segment of said further first trajectory,
for each end point of each segment of said further first trajectory a plurality of predetermined distances between said further first slider and said end point, wherein each predetermined distance of said plurality of predetermined distances is associated with a respective predetermined velocity of said further first blade, with a respective predetermined orientation of said further first blade and with a respective predetermined orientation of a segment of said further first trajectory,
wherein said logic control unit is configured to:
acquire over time a plurality of positions of said further first slider, through said further first position sensor (PS1′),
calculate:
a first position difference between a position of said further first slider acquired in time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said further first trajectory towards said further first blade moves, wherein said position is stored in said storage means, and the position of said further first slider,
the velocity of said further first blade with a module equal to the ratio between said first position difference and said time difference, and
the distance of said further first blade with respect to said end point of said segment of said further first trajectory equal to the result of said second position difference,
when said distance is equal to a predetermined distance of said plurality of predetermined distances, send a signal to said further first blade rotation means for rotating said further first blade in such a way that said further first blade has an orientation equal to a stored predetermined orientation which is selected on the basis of the correspondence between the distance of said further first slider from an end point of said segment of said further first trajectory and a stored predetermined distance and on the correspondence between the calculated velocity of said further first blade and a stored predetermined velocity of said further first blade, so that the aerodynamic behaviour of said further first bladed device changes over time to maximize the amount of kinetic energy of said air flow captured by said further first blade.

9. Wind apparatus according to claim 8, wherein
said further first bladed device comprises further first guide rotation means for rotating said further first guide element in space, and
wherein said logic control unit is configured to send a signal to said further first guide rotation means for rotating said further first guide element in such a way that said further first guide element has an orientation equal to a stored predetermined orientation which is selected on the basis of the correspondence between the distance of said further first slider from an end point of said segment of said further first trajectory and a stored predetermined distance and on the correspondence between the calculated velocity of said further first blade and a stored predetermined velocity of said further first blade, so that the aerodynamic behaviour of said further first bladed device changes over time to further maximize the amount of kinetic energy of said air flow captured by said further first bladed.

10. Wind apparatus according to claim 8, wherein said first motion transmission mechanism comprises:
at least one further first rotating element connected to said further first slider of said further first bladed device in such a way that the movement of said further first slider, due to the movement of said further first blade in said first direction or in said second direction, causes respectively the rotation of said further first rotating element in a first direction or in a second direction, and
further first connecting means for connecting said further first rotating element to said first shaft, in such a way that the rotation of said further first rotating element in said first direction causes the rotation of said first shaft in said predetermined direction or that the rotation of said further first rotating element in said first direction and in said second direction causes the rotation of said first shaft in said predetermined direction,
wherein said first wind system is configured to transfer said amount of kinetic energy to said first shaft, so that the kinetic energy of the air flow is transformed in rotational mechanical energy of said first shaft.

11. Wind apparatus according to claim 8, wherein said motion transmission mechanism further comprises:
connecting means for connecting the first bladed device to the further first bladed device in such a way that, when the first slider of the first bladed device moves in said first direction or in the second direction, the further first slider of the further first bladed device moves in said second direction or in the first direction,
wherein said logic control unit is configured to send a signal to said further first blade rotation means for rotating said further first blade when the distance of said further first bladed with respect to said end point of said segment of said further first trajectory is equal to a stored predetermined distance.

12. Wind apparatus according to claim 11, wherein said logic control unit is configured to send a signal to said further first guide rotation means for rotating said further first guide element, when the distance of said further first blade with respect to said end point of said segment of said further first trajectory is equal to a stored predetermined distance.

13. Wind apparatus according to claim 1, wherein said wind apparatus comprises a second wind system comprising a second bladed device 4, wherein said second bladed device comprises:
a second guide element defining a second trajectory comprising one or more segments, each of which is delimited by a first end point and a second end point,
a second slider sliding on said second guide element in a first direction and in second direction, opposite said first direction,
at least one second blade orientable in space with respect to a direction of an air flow and constrained to said second slider in such a way that, when said air flow incides on said second blade, said air flow moves said second blade and the movement of said second blade causes the movement of said second slider along said second guide element in said first direction or in said second direction,
second blade rotation means for rotating said second blade in space with respect to said second slider,
wherein said second wind system comprises:
a second position sensor for detecting the position of said second blade,
wherein the following data are stored in said storage means:
the position of each end point of each segment of said second trajectory,
for each end point of each segment of said second trajectory a plurality of predetermined distances between said second slider and said end point, wherein each predetermined distance of said plurality of predetermined distances is associated with a respective predetermined velocity of said second bladed, a respective predetermined orientation of said second bladed and a respective predetermined orientation of a segment of said second trajectory;
wherein said logic control unit is configured to:
acquire over time a plurality of positions of said second slider, through said second position sensor,
calculate:
a first position difference between a position of said second slider acquired in a time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said second trajectory towards which the second blade moves, wherein said position is stored in said storage means, and the position of said second slider,
the velocity of said second blade with a module equal to the ratio between said first position difference and said time difference, and
the distance of said second blade with respect to said end point of said segment of said second trajectory equal to the result of said second position difference,
when said distance is equal to a predetermined distance of said plurality of predetermined distances, send a signal to said second blade rotation means for rotating said second blade in such a way that said second blade has an orientation equal to a stored predetermined orientation which is selected on the basis of the correspondence between the distance of said second slider from an end point of said segment of said second trajectory and a stored predetermined distance and on the correspondence between the calculated velocity of said second blade and a stored predetermined velocity of said second blade, so that the aerodynamic behaviour of said second bladed device changes over time to maximize the amount of kinetic energy of said air flow captured by said second blade.

14. Wind apparatus according to claim 13, wherein said second bladed device comprises second guide rotation means for rotating said second guide element in space, wherein
said logic control unit is configured to send a signal to said second guide rotation means for rotating said second guide element in such a way that said second guide element has an orientation equal to a stored predetermined orientation which is selected on the basis of the correspondence between the distance of said second slider from an end point of said segment of said second trajectory and a stored predetermined distance and on the correspondence between the calculated velocity of said second blade and a stored predetermined velocity of said second blade, so that the aerodynamic behaviour of said second bladed device changes over time to further maximize the amount of kinetic energy of said air flow captured by said second blade.

15. Wind apparatus according to claim 14, wherein said second wind system comprises:
at least one second velocity sensor for detecting the velocity of the air flow incident on said second blade,
at least one second force sensor for detecting a force acting on said second blade;
wherein the following data are stored in said storage means:
a plurality of predetermined air flow velocities,
a plurality of predetermined forces, wherein each of predetermined force of said plurality of predetermined forces is associated with a respective predetermined air flow velocity of said plurality of predetermined air flow velocities, a respective predetermined velocity of said second slider, a respective predetermined orientation of said second blade and a respective predetermined orientation of said segment of said second trajectory on which said second blade moves to reach an end point,
wherein said logic control unit is configured to:
acquire a plurality of air flow velocities over time, through said second velocity sensor,
acquire a plurality of forces acting on said second blade over time, through said second force sensor,
compare the velocity of the air flow detected through said second velocity sensor with each stored predetermined air flow velocity in said storage means, and
the velocity of said second blade with each predetermined velocity of said second blade stored in said storage means,
to obtain a predetermined force selected on the basis of the correspondence between the acquired air flow velocity and a stored predetermined air flow velocity and of the correspondence between the calculated velocity of said second blade and a stored predetermined velocity of said second blade,
compare each acquired force with said predetermined force, and
if an acquired force is less than said predetermined force, send a signal to said second blade rotation means for rotating said second blade in such a way that said second blade has an orientation equal to a stored predetermined orientation which is selected on the basis of said predetermined force.

16. Wind apparatus according to claim 15, wherein said logic control unit is configured to send a signal to said guide rotation means for rotating said second guide element in such a way that said second guide element has an orientation equal to a stored predetermined orientation which is selected on the basis of the correspondence between the acquired air flow velocity and a stored predetermined air flow and on the correspondence between the calculated velocity of said second blade and a stored predetermined velocity of said second blade.

17. Wind apparatus according to claim 13, wherein said second wind system comprises:
a second motion transmission mechanism comprising:
at least one second rotating element connected to said second slider in such a way that the movement of said second slider, due to the movement of said second blade in said first direction or in said second direction, causes respectively the rotation of said second rotating element in a fist direction or in a second direction,
a second shaft having a rotation axis and configured to rotate around said rotation axis in a predetermined direction, and
second connecting means for connecting said second rotating element to said second shaft, in such a way that the rotation of said second rotating element in said first direction causes the rotation of said second shaft in said predetermined direction or that the rotation of said second rotating element in said first direction and said second direction causes the rotation of said second shaft in said predetermined direction,
wherein said second wind system is configured to transfer said amount of kinetic energy to said second shaft, so that the kinetic energy of the air flow is transformed in rotational mechanical energy of said second shaft.

18. Wind apparatus according to claim 6, wherein said motion transmission mechanism for transmitting the motion from said drive shaft comprises connecting means for connecting said second shaft to said drive shaft, so that the rotation of said first shaft and the rotation of said second shaft cause the rotation of said drive shaft.

19. Wind apparatus according to claim 18, wherein said wind apparatus comprises a third wind system and said third wind system comprises:
a third bladed device comprises:
a third guide element having a curvilinear or substantial curvilinear shape defining a third trajectory comprising a plurality of segments, wherein each segment of said plurality of segments is delimited by a first end point and a second end point,
a third slider sliding on said third guide element in a first direction and in a second direction, opposite to said first direction,
at least one third blade orientable in space with respect to a direction of an air flow and constrained to said third slider in such a way that, when said air flow incides on said third blade, said air flow moves said third blade and the movement of said third blade causes the movement of said third slider along said third guide element in said first direction or in said second direction,
third blade rotation means for rotating said third blade in space with respect to said third slider,
wherein said third wind system comprises:
at least one third position sensor for detecting the position of said third blade,
wherein the following data are stored in said storage means:
the position of each end point of each segment of said third trajectory,
for each end point of each segment of said third trajectory a plurality of predetermined distances between said third slider and said end point, wherein each predetermined distance of said plurality of predetermined distances is associated with a respective predetermined velocity of said third blade, and a respective predetermined orientation of said third blade,
wherein said logic control unit is configured to:
acquire a plurality of position values associated with said third slider over time, through said third position sensor,
calculate:
a first position difference between a position of said third slider acquired in a time instant tⱼ, with j=1, 2 . . . N, wherein N is a positive integer, and a position acquired in a previous time instant tⱼ₋₁,
a time difference between said time instant tⱼ and said previous time instant tⱼ₋₁,
a second position difference between the position of an end point of a segment of said third trajectory towards which the third blade moves, wherein said position is stored in said storage means, and the position of said third slider,
the velocity of said third blade with a module equal to the ratio between said first position difference and said time difference, and
the distance of said third blade with respect to said end point of said segment of said third trajectory equal to the result of said second position difference,
when said distance is equal to a predetermined distance of said plurality of predetermined distances, send a signal to said third blade rotation means for rotating said third blade in such a way that said third blade has an orientation equal to a stored predetermined orientation which is selected on the basis of the correspondence between the distance of said third slider from an end point of said segment of said third trajectory and a stored predetermined distance and on the basis of the calculated velocity of said third blade and a stored predetermined velocity of said third blade, so that the aerodynamic behaviour of said third bladed device changes over time to maximize the amount of kinetic energy of said air flow captured by said third blade.

20. Wind apparatus according to claim 19, wherein said third wind system comprises:
at least one third velocity sensor for detecting the velocity of the air flow incident on said third blade,
at least one third force sensor for detecting a force acting on said third blade;
wherein the following data are stored in said storage means:
a plurality of predetermined air flow velocities,
a plurality of predetermined forces, wherein each predetermined force of said predetermined forces is associated with a respective predetermined air flow velocity of said predetermined air flow velocities, a respective predetermined velocity of said third slider, a respective predetermined orientation of said third blade,
wherein said logic control unit is configured to:
acquire a plurality of air flow velocities over time, through said third velocity sensor,
acquire a plurality of forces acting on said third blade over time, through said third force sensor,
compare the velocity of the air flow detected through said third velocity sensor with each predetermined air flow velocity stored in said storage means, and
the velocity of said third blade with each predetermined velocity of said third blade stored in said storage means,
to obtain a predetermined force selected on the basis of the correspondence between the acquired air flow velocity and a stored predetermined air flow velocity and on the correspondence between the calculated velocity of said third blade and a stored predetermined velocity of said third blade,
compare each acquired force with said predetermined force, and
if an acquired force is less than said predetermined force, send a signal to said blade rotation means for rotating said third blade in such a way that said third blade has an orientation equal to a stored predetermined orientation which is selected on the basis of said predetermined force.

21. Wind apparatus according to claim 20, wherein said third wind system comprises:
a third motion transmission mechanism comprising:
at least one third rotating element connected to said third slider in such a way that the movement of said third slider, due to the movement of said third blade in said first direction or in said second direction, causes respectively the rotation of said third rotating element in a first direction or in a second direction,
a third shaft having a rotation axis and configured to rotate around said rotation axis in a predetermined direction, and
third connecting means for connecting said third rotating element and said third shaft, in such a way that the rotation of said third rotating element 3 in said first direction and in said second direction causes the rotation of said third shaft in said predetermined direction,
wherein said third wind system is configured to transfer said amount of kinetic energy to said third shaft, so that the kinetic energy of the air flow is transformed in rotational mechanical energy of said third shaft.

22. Wind apparatus according to claim 21, wherein said motion transmission mechanism for transmitting the motion to said drive shaft comprises connecting means for connecting said third shaft to said drive shaft, so that the rotation of said first shaft, of said second shaft and of said third shaft cause the rotation of said drive shaft.
